(19) United States
(12) Patent Application Publication
(10) Pub. No.: US 2021/0187421 A1
(43) Pub. Date: Jun. 24, 2021

(54) FILTER MEDIA COMPRISING A NON-WETLAID BACKER

(71) Applicant: Hollingsworth & Vose Company, East Walpole, MA (US)

(72) Inventors: David T, Healey, Bellingham, MA (US); Bruce Smith, Copper Hill, VA (US); Jennifer Dana Leary, Floyd, VA (US); Greg Wagner Farell, Radford, VA (US)

(73) Assignee: Hollingsworth & Vose Company, East Walpole, MA (US)

(21) Appl. No.: 16/721,788

(22) Filed: Dec. 19, 2019

(51) Int. Cl. B01D 39/16; D04H 1/4374; D04H 1/4391; D04H 1/58; D04H 1/732; D04H 1/435

(52) U.S. Cl. CPC B01D 39/163; D04H 1/4374; D04H 1/43918; D04H 1/58; B01D 2239/1233; D04H 1/435; B01D 2239/0618; B01D 2239/0681; D04H 1/732

(57) ABSTRACT

Filter media comprising a non-wetlaid backer are generally provided. In some embodiments, a filter media comprises a non-wetlaid fiber web and further comprises one or more further fiber webs. The further fiber web(s) may include an efficiency layer and/or a prefilter.

### FIELD

The present invention relates generally to filter media, and, more particularly, to filter media comprising a non-wetlaid backer.

### BACKGROUND

Filter media may be used to remove one or more contaminants from a fluid. Some filter media comprise wetlaid backers. However, wetlaid backers often exhibit undesirably high air resistance. Accordingly, improved filter media and associated compositions and methods are needed.

### SUMMARY

Filter media, related components, and related methods are generally described.

In some embodiments, a filter media comprises three fiber webs. The first fiber web is a non-wetlaid fiber web comprising a resin. The second fiber web comprises fibers having an average diameter of greater than or equal to 0.01 micron and less than or equal to 1 micron. The third fiber web comprises fibers having an average diameter of greater than or equal to 0.8 microns and less than or equal to 8 microns. A ratio of a machine direction tensile strength of the filter media to a cross direction tensile strength of the filter media is greater than or equal to 2 and less than or equal to 10.

In some embodiments, a filter media comprises three fiber webs. The first fiber web is a non-wetlaid fiber web comprising a resin. The second fiber web comprises fibers having an average diameter of greater than or equal to 0.01 micron and less than or equal to 1 micron. The third fiber web comprises fibers having an average diameter of greater than or equal to 0.8 microns and less than or equal to 8 microns. The filter media has an “F” classification of F1 and/or has a “K” classification of K1.

In some embodiments, a filter media comprises three fiber webs. The first fiber web is a non-wetlaid fiber web comprising fibers and a resin. Both the fibers and the resin comprise a poly(ester), and the poly(ester) in the fibers and the poly(ester) in the resin together make up greater than or equal to 50 wt % and less than or equal to 100 wt % of the first fiber web. The second fiber web comprises fibers having an average diameter of greater than or equal to 0.01 micron and less than or equal to 1 micron. The third fiber web comprises fibers having an average diameter of greater than or equal to 0.8 microns and less than or equal to 8 microns.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a non-limiting embodiment of a filter media, in accordance with some embodiments;

FIG. 2 shows a non-limiting embodiment of a filter media comprising two layers, in accordance with some embodiments; and

FIG. 3 shows a non-limiting embodiment of a filter media comprising three layers, in accordance with some embodiments.

### DETAILED DESCRIPTION

Articles and methods involving filter media are generally provided. In some embodiments, a filter media comprises a combination of components that causes the filter media to have one or more beneficial properties. For instance, the filter media may comprise a combination of components that causes the filter media to have favorable mechanical properties, such as a relatively high tensile strength and/or a relatively high stiffness. As another example, the filter media may comprise a combination of components that causes the filter media to have a relatively low air resistance. As a third example, the filter media may comprise a combination of components that causes the filter media to be relatively flame resistant and/or flame retardant. Such filter media may have a relatively high “F” or “K” rating. As a fourth example, a filter media may be recyclable.

The filter media described herein may have a combination of structural features that promote one or more of the above-mentioned beneficial properties. By way of example, in some embodiments, a filter media comprises a backer that is a non-wetlaid fiber web and that comprises a resin. The non-wetlaid fiber web may have a beneficially low air resistance and may be sufficiently strengthened by the resin such that it has a desirable strength and/or stiffness. The resin may be present in an amount and/or manner that bonds together the fibers in the non-wetlaid fiber web in a manner that increases its strength and/or stiffness (in some cases, appreciably) without appreciably decreasing its openness, thus enhancing its mechanical properties while preserving its low air resistance.

In some embodiments, a filter media has a chemical composition that promotes one or more of the above-mentioned beneficial properties. For instance, a filter media may comprise one or more components (e.g., one or more fiber webs) that are flame resistant and/or flame retardant. Such components may comprise flame resistant and/or flame retardant fibers (e.g., fibers formed from and/or comprising polymers that are flame resistant and/or flame retardant, such as poly(ester)s, and/or fibers comprising one or more flame retardants) and/or may comprise a resin comprising one or more materials that are flame resistant and/or one or more flame retardants. As another example, a filter media may lack components that hinder its ability to be recycled, such as glass. Some filter media described herein may include fiber webs that are 100 wt % synthetic, and/or may be 100 wt % synthetic as a whole.

The filter media described herein may be suitable for filtering a variety of fluids, one of which is air. Some embodiments relate to methods of filtering a fluid (e.g., air) by passing the fluid through the filter media (e.g., when it is positioned in a filter element).

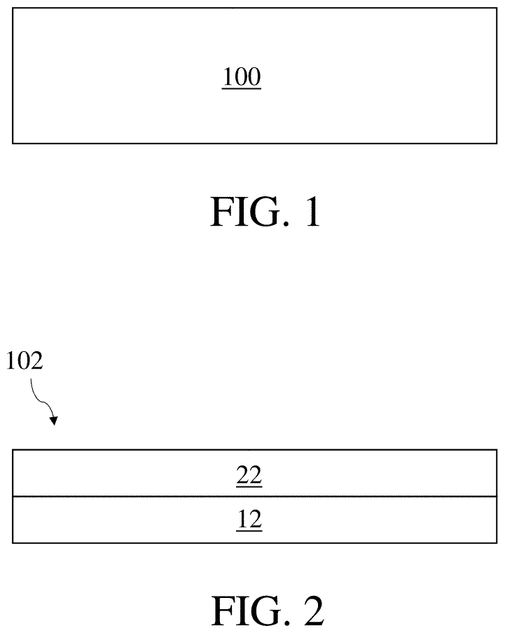

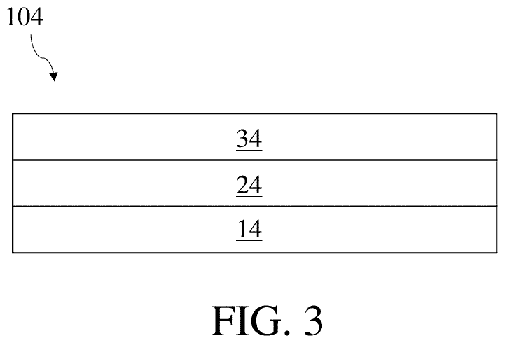

The filter media described herein are typically formed from one or more components. Such components may take the form of fiber webs (e.g., non-woven fiber webs) and/or layers. FIG. 1 shows one non-limiting embodiment of a filter media 100. As shown in FIGS. 2 and 3, respectively, the filter media may comprise two or three layers. FIG. 2 shows a filter media 102 comprising a first fiber web 12 and a second fiber web 22. FIG. 3 shows a filter media 104 comprising a first fiber web 14, a second fiber web 24, and a third fiber web 34.

The first, second, and third fiber webs shown in the filter media of FIG. 3 may be referred to elsewhere herein as a “backer”, an “efficiency layer”, and a “prefilter”, respectively. These references should be understood to be for convenience and to convey functionality that these fiber webs may have when appropriately designed and arranged. However, fiber webs recited in the claims should not be understood to necessarily have the components or properties of a backer, efficiency layer, or prefilter unless explicitly reciting such components or properties. In other words, it should be understood that a reference to a “first” fiber web in the claims may not necessarily be reference to a backer as described herein, a reference to a “second” fiber web in the claims may not necessarily be a reference to an efficiency layer described herein, and/or references to a “third” fiber web in the claims may not necessarily be a reference to a prefilter described herein. By way of example, a “first” fiber web may have one or more properties in common with the efficiency layers and/or prefilters described herein, may lack one or more properties of the backers described herein, may have a functionality in the filter media similar to that of an efficiency layer and/or a prefilter, and/or may lack the functionality of a backer.

It should also be understood that backers, efficiency layers, and prefilters may comprise further components in addition to fiber webs.

In some embodiments, like the embodiment shown in FIG. 3, a filter media may comprise exactly three fiber webs. These three fiber webs may be a backer, an efficiency layer, and a prefilter. Like in FIG. 3, the efficiency layer may be positioned between the backer and the prefilter. The efficiency layer may be disposed on the backer (e.g., directly, indirectly) and/or the prefilter may be disposed on the efficiency layer (e.g., directly, indirectly). However, filter media comprising different numbers, types, and/or arrangements of fiber webs than those shown in FIG. 3 are also possible. For instance, a filter media may comprise four fiber webs, five fiber webs, or more fiber webs. As another example, a filter media may lack a backer and/or may lack a prefilter. As a third example, a filter media may comprise two or more backers, two or more efficiency layers, and/or two or more prefilters.

As used herein, when a component is referred to as being “on” or “adjacent” another component, it can be directly on or adjacent the component, or an intervening component also may be present. A component that is “directly on”, “directly adjacent” or “in contact with” another component means that no intervening component is present.

In some embodiments, a filter media comprises one or more components other than a backer, an efficiency layer, and a prefilter. Such components may take the form of layers or may not. As an example, a filter media may comprise an adhesive positioned between two or more components (e.g., between a backer and an efficiency layer, between an efficiency layer and a prefilter, between a first fiber web and a second fiber web, between a second fiber web and a third fiber web). The adhesive may assist with bonding the layers together. As another example, a filter media may comprise a cover layer, as described in further detail elsewhere herein.

As described above, some filter media include a backer. The backer may support one or more other components of the filter media (e.g., a fiber web comprising nanofibers) and/or may be a component of the filter media onto which another component of the filter media was deposited during fabrication of the filter media. For example, in some embodiments, a filter media may comprise a backer onto which an efficiency layer was deposited. The backer may provide structural support and/or enhance the ease with which the filter media may be fabricated without appreciably increasing the resistance of the filter media. In some embodiments, the backer does not contribute appreciably to the filtration performance of the filter media. In other embodiments, the backer may enhance the performance of the filter media in one or more ways (e.g., it may be positioned upstream of other components of the filter media and/or may serve as a prefilter). It should be understood that any individual backer may independently have some or all of the properties described herein with respect to backers.

When present, a backer may comprise a non-woven fiber web. In some embodiments, the non-woven fiber web is a non-wetlaid non-woven fiber web. In other words, the non-woven fiber web may be a fiber web that is fabricated by a process other than a wetlaid process. Fiber webs fabricated by non-wetlaid processes may advantageously include fibers that are relatively long (e.g., staple fibers having lengths of greater than or equal to 0.75 in, continuous fibers), have relatively large diameters (which may reduce the cost), and/or that include crimps. Advantageously, non-wetlaid non-woven fiber webs (e.g., having one or more of the above-referenced properties) may be relatively open and/or may have relatively low values of air resistance (e.g., in comparison to wetlaid non-woven fiber webs).

In embodiments in which a filter media comprises two or more backers, each backer may independently comprise a non-woven fiber web having one or more of the properties described above and/or one or more of the types of fibers described above.

In some embodiments, non-wetlaid non-woven fiber webs may have a combination of properties that are challenging or impossible to obtain in wetlaid non-woven fiber webs. By way of example, it may be possible and/or relatively facile to fabricate relatively thin non-wetlaid non-woven fiber webs that have a relatively low density, while it may be challenging or impossible to fabricate wetlaid non-woven fiber webs that are both relatively thin and have a relatively low density. Without wishing to be bound by any particular theory, it is believed that wetlaying processes involve transporting an unbonded non-woven fiber web across a gap over which the unbonded non-woven fiber web is unsupported. It is also believed that unbonded non-woven fiber webs must be relatively thick and/or relatively dense to have sufficient mechanical integrity to be transported across such gaps without being destroyed, and that this causes the resultant wetlaid fiber webs to be undesirably thick and/or dense.

Non-limiting examples of suitable non-wetlaid non-woven fiber webs include carded non-woven fiber webs, meltblown non-woven fiber webs, airlaid non-woven fiber webs, spunlaid non-woven fiber webs (e.g., non-woven fiber webs comprising spunlaid filaments), and spunbond non-woven fiber webs.

In embodiments in which a filter media comprises two or more backers, each backer may independently comprise one of the non-woven fiber webs described above and/or one or more of the types of fibers described above.

In some embodiments, a backer comprises synthetic fibers and/or is made up of synthetic fibers (e.g., it may comprise and/or be a synthetic fiber web). In some embodiments, synthetic fibers make up a relatively high percentage of a backer. For instance, synthetic fibers may make up greater than or equal to 50 wt %, greater than or equal to 60 wt %, greater than or equal to 70 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the fibers in the backer. In some embodiments, synthetic fibers make up less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 70 wt %, or less than or equal to 60 wt % of the fibers in the backer. Combinations of the above-referenced ranges are also possible (e.g., greater than or equal to 50 wt % and less than or equal to 100 wt %, greater than or equal to 90 wt % and less than or equal to 100 wt %, or greater than or equal to 95 wt % and less than or equal to 100 wt %). Other ranges are also possible. In some embodiments, 100 wt % of the fibers in the backer are synthetic fibers. In some embodiments, synthetic material makes up 100 wt % of the backer.

In embodiments in which a filter media comprises two or more backers, each backer may independently comprise an amount of synthetic fibers and/or synthetic material in one or more of the ranges described above.

Some embodiments relate to backers comprising a relatively high amount of fibers comprising poly(ester). Without wishing to be bound by any particular theory, it is believed that poly(ester) has flame resistant properties and so filter media components comprising poly(ester) (e.g., backers, fibers in backers, resins in backers) may have enhanced flame resistance. By way of example, poly(ethylene terephthalate), a type of poly(ester), has a limiting oxygen index of 21%, which is relatively high. It is believed that poly(ester)s comprising aromatic rings, such as poly(ethylene terephthalate), may be particularly flame resistant because the aromatic rings may have a high resistance to flammability.

Fibers comprising poly(ester) may make up greater than or equal to 0 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 75 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the fibers in a backer. In some embodiments, fibers comprising poly(ester) make up less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 75 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 10 wt % of the fibers in the backer. Combinations of the above-referenced ranges are also possible (e.g., greater than or equal to 0 wt % and less than or equal to 100 wt %, greater than or equal to 50 wt % and less than or equal to 100 wt %, or greater than or equal to 85 wt % and less than or equal to 100 wt %). Other ranges are also possible. In some embodiments, 100 wt % of the fibers in the backer comprise poly(ester). In some embodiments, 0 wt % of the fibers in the backer comprise poly(ester).

In embodiments in which a backer comprises two or more types of fibers comprising a poly(ester) (e.g., monocomponent fibers comprising a poly(ester) and bicomponent fibers comprising a poly(ester) component), it should be understood that each type of fiber comprising a poly(ester) may independently make up a wt % of the backer in one or more of the ranges described above and/or that all the fibers comprising poly(ester) may together make up a wt % of the backer in one or more of the ranges described above. It should also be understood that, for filter media comprising two or more backers, each backer may independently comprise one or more types of fibers comprising a poly(ester) making up a wt % of the backer in one or more of the ranges described above and/or may have a total amount of fibers comprising poly(ester) that make up a wt % of the backer in one or more the ranges described above.

Some backers comprise monocomponent synthetic fibers. The monocomponent synthetic fibers may include binder fibers (e.g., fibers adhering together other fibers within the backer) and/or may include non-binder fibers (e.g., fibers not themselves adhering together other fibers within the backer, but possibly adhered together by one or more other components of the backer, such as a resin). Monocomponent binder fibers typically have compositions similar to those of multicomponent fibers and so are discussed in further detail where multicomponent fibers are discussed. Monocomponent synthetic fibers not identified as being monocomponent binder fibers should be understood to refer to monocomponent synthetic non-binder fibers.

Non-limiting examples of suitable monocomponent synthetic fibers include monocomponent fibers comprising one or more of the following materials: poly(olefin)s (e.g., poly(propylene)), poly(ester)s (e.g., poly(ethylene terephthalate), poly(butylene terephthalate)), co(polyester)s, poly(amide)s (e.g., nylon 6, 66, 11, 12, 612; meta aramids), poly(acrylonitrile), poly(tetrafluoroethylene) (PTFE), poly(ether ketone) (PEEK), poly(ether ketone) (PEK), poly(phenylene sulfide) (PPS), poly(sulfone) (PES), melamine, poly(carbonate), poly(heterocyclic) compounds, poly(benzidiazole) (PBI), poly(lactic acid), and rayon.

The backers described herein may include more than one type of monocomponent synthetic fiber (e.g., two or more different types of monocomponent synthetic fibers, such as poly(ethylene) fibers and poly(ester) fibers) or may include exclusively one type of monocomponent synthetic fiber (e.g., exclusively monocomponent synthetic fibers comprising poly(ethylene)). In some embodiments, the fibers in the backer comprise monocomponent synthetic fibers comprising a blend of two or more of the polymers listed above (e.g., a blend of two types of poly(ester)). It should also be understood that the backers described herein may comprise (or may lack) further types of fibers (such as those described below).

When present, monocomponent synthetic fibers may make up a variety of suitable amounts of the fibers in a backer. In some embodiments, monocomponent synthetic fibers make up greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, or greater than or equal to 70 wt % of the fibers in the backer. In some embodiments, monocomponent synthetic fibers make up less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, or less than or equal to 7.5 wt %. Combinations of the above-referenced ranges are also possible (e.g., greater than or equal to 5 wt % and less than or equal to 75 wt %, greater than or equal to 10 wt % and less than or equal to 60 wt %, greater than or equal to 15 wt % and less than or equal to 50 wt %, or greater than or equal to 10 wt % and less than or equal to 30 wt %). Other ranges are also possible.

In embodiments in which a backer comprises two or more types of monocomponent synthetic fibers (e.g., monocomponent fibers comprising a poly(ester) and monocomponent fibers comprising poly(ethylene)), it should be understood that each type of monocomponent synthetic fiber may independently make up a wt % of the backer in one or more of the ranges described above and/or that all the monocomponent synthetic fibers may together make up a wt % of the backer in one or more of the ranges described above. It should also be understood that, for filter media comprising two or more backers, each backer may independently comprise one or more types of monocomponent synthetic fibers making up a wt % of the backer in one or more of the ranges described above and/or may have a total amount of monocomponent synthetic fibers that make up a wt % of the backer in one or more the ranges described above.

As described above, some backers comprise multicomponent fibers and/or monocomponent binder fibers. The multicomponent fibers may comprise bicomponent fibers (i.e., fibers including two components), and/or may comprise fibers comprising three or more components. Multicomponent fibers may have a variety of suitable structures. For instance, a backer may comprise one or more of the following types of bicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, binding other fibers within the fiber web together while the core remains solid. In some embodiments, a backer may comprise a multicomponent fiber that initially had one of the above-referenced structures, but underwent a process (e.g., a splitting process) during fabrication of the filter media to form a different structure. By way of example, some backers may comprise fibers that were initially bicomponent fibers but were split during filter media fabrication (e.g., during backer fabrication) to form finer fibers. Such finer fibers may undergo hydroentangling on the production line before the backer is wound up and/or before any binding step is performed.

In embodiments in which a filter media comprises two or more backers, each backer may independently comprise one or more of the types of multicomponent fibers described above.

Non-limiting examples of suitable materials that may be included in multicomponent fibers and/or monocomponent binder fibers include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460, such as diethylene ether glycol).

In embodiments in which a backer comprises two or more types of bicomponent fibers and/or monocomponent binder fibers, each type of bicomponent fiber and/or monocomponent binder fiber may independently comprise one or more of the types of materials described above. Similarly, in embodiments in which a filter media comprises two or more backers, each backer may independently comprise one or more types of bicomponent fibers and/or one or more types of monocomponent binder fibers, each of which may independently comprise one or more of the types of materials described above.

Co-poly(ethylene terephthalate)s may include repeat units formed by polymerization of comonomers (e.g., monomers other than ethylene glycol and terephthalic acid) in a variety of suitable amounts. For instance, a co-poly(ethylene terephthalate) may be formed from a mixture of monomers in which the comonomer may make up greater than or equal to 0.5 mol %, greater than or equal to 0.75 mol %, greater than or equal to 1 mol %, greater than or equal to 1.5 mol %, greater than or equal to 2 mol %, greater than or equal to 3 mol %, greater than or equal to 5 mol %, greater than or equal to 7.5 mol %, greater than or equal to 10 mol %, or greater than or equal to 12.5 mol % of the total amount of monomers. The co-poly(ethylene terephthalate) may be formed from a mixture of monomers in which the comonomer makes up less than or equal to 15 mol %, less than or equal to 12.5 mol %, less than or equal to 10 mol %, less than or equal to 7.5 mol %, less than or equal to 5 mol %, less than or equal to 3 mol %, less than or equal to 2 mol %, less than or equal to 1.5 mol %, less than or equal to 1 mol %, or less than or equal to 0.75 mol % of the total amount of monomers. Combinations of the above-referenced ranges are also possible (e.g., greater than or equal to 0.5 mol % and less than or equal to 15 mol %). Other ranges are also possible.

In embodiments in which a co-poly(ethylene terephthalate) comprises two or more types of repeat units formed by polymerization of a comonomer, each type of repeat unit may independently make up a mol % of the total amount of monomers from which the co-poly(ethylene terephthalate) is formed in one or more of the ranges described above and/or all of the comonomers together may make up a mol % of the total amount of monomers from which the co-poly(ethylene terephthalate) is formed in one or more of the ranges described above.

In some embodiments, a backer comprises multicomponent fibers and/or monocomponent binder fibers comprising one or more poly(ester)s in a relatively large amount. For instance, one or more poly(ester)s may make up greater than or equal to 0 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 75 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the multicomponent fibers and/or monocomponent binder fibers. In some embodiments, a backer comprises multicomponent fibers and/or monocomponent binder fibers for which poly(ester)s make up less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 75 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 10 wt % of the multicomponent fibers and/or monocomponent binder fibers. Combinations of the above-referenced ranges are also possible (e.g., greater than or equal to 0 wt % and less than or equal to 100 wt %, greater than or equal to 50 wt % and less than or equal to 100 wt %, or greater than or equal to 90 wt % and less than or equal to 100 wt %). Other ranges are also possible. In some embodiments, a backer comprises multicomponent fibers and/or monocomponent binder fibers for which one or more poly(ester)s makes up 100 wt % of the fibers. In some embodiments, a backer comprises multicomponent fibers and/or monocomponent binder fibers for which poly(ester)s make up 0 wt % of the fibers. The wt % of poly(ester) in a fiber may be determined by nuclear magnetic resonance.

In embodiments in which a multicomponent fiber and/or monocomponent binder fiber comprises one or more poly(ester)s, each poly(ester) may independently make up a wt % of the multicomponent fiber and/or monocomponent binder fiber in one or more of the ranges described above and/or all of the poly(esters) may together may make up a mol % of the multicomponent fiber and/or monocomponent binder fiber in one or more of the ranges described above.

Non-limiting examples of suitable pairs of materials that may be included in bicomponent fibers include poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-poly(amide)/poly(amide), and poly(ethylene)/poly(propylene). In the preceding list, the material having the lower melting temperature is listed first and the material having the higher melting temperature is listed second. Core-sheath bicomponent fibers comprising one of the above such pairs may have a sheath comprising the first material and a core comprising the second material.

In embodiments in which a backer comprises two or more types of bicomponent fibers, each type of bicomponent fiber may independently comprise one of the pairs of materials described above. Similarly, in embodiments in which a filter media comprises two or more backers, each backer may independently comprise one or more types of bicomponent fibers, each of which may independently comprise one of the pairs of materials described above.

The multicomponent fibers described herein may comprise components having a variety of suitable melting points. In some embodiments, a multicomponent fiber comprises a component having a melting point of greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., or greater than or equal to 220° C. In some embodiments, a multicomponent fiber comprises a component having a melting point less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., or less than or equal to 90° C. Combinations of the above-referenced ranges are also possible (e.g., greater than or equal to 80° C. and less than or equal to 230° C., or greater than or equal to 110° C. and less than or equal to 230° C.). Other ranges are also possible. In some embodiments, a multicomponent fiber comprises a component having a melting point of less than or equal to 100° C. The melting point of the components of a multicomponent fiber may be determined by performing differential scanning calorimetry. The differential scanning calorimetry measurement may be carried out by heating the multicomponent fiber to 300° C. at 20° C./minute, cooling the multicomponent fiber to room temperature, and then determining the melting point during a reheating to 300° C. at 20° C./minute.

It should be understood that each component of a multicomponent fiber may individually have a melting point in one or more of the ranges described above. It should also be understood that some multicomponent fibers may include one or more components having a melting point outside of the ranges described above (e.g., a component having a melting point in excess of 230° C.). In some embodiments, a monocomponent binder fiber has a melting point in one or more of the ranges described above.

The backers described herein may include a variety of suitable amounts of multicomponent fibers and/or monocomponent binder fibers. In some embodiments, multicomponent fibers and/or monocomponent binder fibers make up greater than or equal to 10 wt %, greater than or equal to 15 wt %, greater than or equal to 20 wt %, greater than or equal to 25 wt %, greater than or equal to 30 wt %, greater than or equal to 40 wt %, greater than or equal to 45 wt %, greater than or equal to 50 wt %, greater than or equal to 60 wt %, greater than or equal to 70 wt %, greater than or equal to 75 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the fibers in the backer. In some embodiments, multicomponent fibers and/or monocomponent binder fibers make up less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 75 wt %, less than or equal to 70 wt %, less than or equal to 60 wt %, less than or equal to 50 wt %, less than or equal to 45 wt %, less than or equal to 40 wt %, less than or equal to 30 wt %, less than or equal to 25 wt %, less than or equal to 20 wt %, or less than or equal to 15 wt % of the fibers in the backer. Combinations of the above-referenced ranges are also possible (e.g., greater than or equal to 10 wt % and less than or equal to 100 wt %, greater than or equal to 10 wt % and less than or equal to 80 wt %, greater than or equal to 20 wt % and less than or equal to 50 wt %, greater than or equal to 30 wt % and less than or equal to 90 wt %, greater than or equal to 50 wt % and less than or equal to 85 wt %, or greater than or equal to 70 wt % and less than or equal to 90 wt %). Other ranges are also possible.

It should be understood that any of the following may independently make up a wt % of a backer in one or more of the ranges described above: (1) a particular type of multicomponent fiber in the backer; (2) all of the multicomponent fibers in the backer together; (3) a particular type of monocomponent binder fiber in the backer; (4) all of the monocomponent binder fibers in the backer together; and (5) all of the multicomponent fibers and monocomponent binder fibers in the backer together. It should also be understood that a filter media may comprise two or more backers, for which the above may independently be true for each.

In some embodiments, a backer comprises fibers that are non-synthetic and/or non-polymeric (e.g., non-thermoplastic). For instance, a backer may comprise conductive fibers (e.g., carbon fibers, metal fibers) and/or natural fibers (e.g., cellulose, flax, jute). Such fibers may be present in relatively small amounts. Without wishing to be bound by any particular theory, it is believed that conductive fibers may be advantageous because they may assist with the dissipation of static electricity that may build up during the manufacturing and/or use of the filter media (e.g., during filtering).

In some embodiments, a backer may comprise one or more types of fibers (e.g., monocomponent fibers, monocomponent binder fibers, multicomponent fibers) that are flame resistant and/or flame retardant. Flame resistant fibers may be fibers that are relatively slow to burn. For instance, some flame resistant fibers may begin burning later than poly(olefin) fibers and/or poly(acrylic) fibers when the procedure described in DIN 534381-3 (1984) and/or the procedure described in DIN 534381-2 (1984) is performed thereon. Flame retardant fibers may be fibers that have a rating of F1, F2, or F3 as determined by performing the procedure described in DIN 534381-3 (1984) thereon and/or a rating of K1, K2, or K3 as determined by performing the procedure described in DIN 534381-2 (1984) thereon. The flame resistant and/or flame retardant fibers may enhance the ability of the backer to resist catching on fire. One non-limiting examples of a suitable flame resistant fiber is a fiber comprising a poly(ester). Non-limiting examples of suitable flame retardant fibers include those comprising a phosphorus-based flame retardant (e.g., a phosphate ester, a phosphonate, a phosphine oxide, red phosphorus, an inorganic phosphate, and/or a derivative thereof), and/or those comprising a nitrogen-based flame retardant (e.g., a hindered amine light stabilizer, such as one described elsewhere herein, melamine, dicyanodiamide, guanidine, and/or a derivative thereof).

Fibers in a backer may comprise a flame retardant that is covalently attached to one or more components therein. For instance, a polymer in a fiber may comprise a flame retardant. In some such embodiments, the flame retardant may form a portion of the backbone of the polymer and/or may take the form of one or more pendant groups attached to the backbone of the polymer. Polymers comprising flame retardants may be synthesized in a variety of suitable manners. For instance, in some embodiments, a polymer comprising a flame retardant is formed by reacting one or more functional groups on the polymer (e.g., one or more functional pendant functional groups) with a flame retardant. Non-limiting examples of polymers that may be modified with flame retardants include poly(ester)s (e.g., in the case of a phosphorus-based flame retardant and/or a nitrogen-based flame retardant), poly(olefin)s, poly(styrene)s, styrene copolymers, vinyl chloride polymers, vinyl polymers, poly(amide)s, poly(carbonate)s, poly(urethane)s, poly(epoxide)s, and rayon.

Some flame resistant and/or flame retardant polymers may be formed by polymerizing a monomer that is flame resistant and/or comprises a flame retardant. The monomer may be polymerized to form a homopolymer that is flame resistant and/or flame retardant or may be copolymerized with one or more other monomers to form a copolymer that is flame resistant and/or flame retardant. As an example, a caprolactone may be homopolymerized and/or copolymerized with one or more other monomers. As a second example, an alcohol may be reacted with an acid to form a poly(ester). As a third example, an esterification reaction involving terephthalic acid and ethylene glycol in the presence of a flame retardant may be performed. As a fourth example, a flame retardant copolymer may be synthesized by performing a transesterification reaction involving ethylene glycol and dimethyl terephthalate in the presence of a flame retardant. Such reactions may result in the formation of poly(ethylene terephthalate)s to which a flame retardant is covalently attached. Further non-limiting examples of suitable monomers that may be copolymerized with a flame retardant monomer includes esters, olefins, styrenes, vinyl chlorides, vinyl monomers, amine monomers, monomers comprising one or more carboxylic acid functional groups, bisphenols, phosgene, epoxy, isocyanate, and polyols.

In some embodiments, a fiber comprises a flame retardant that is not covalently attached to a component of the fiber. For instance, a flame retardant may be added to the material used to form the fiber prior to fiber formation and then a fiber may be formed therefrom. This may result in the formation of fibers that comprise the flame retardant but in which the flame retardant is not covalently attached to any other component therein.

Flame resistant and/or flame retardant polymers formed by the processes described (and/or formed by other processes) may be incorporated into fibers prior to formation of the backer (e.g., in the case of staple fibers) and/or during formation of the backer (e.g., in the case of continuous fibers).

It should be understood that each backer may independently comprise two or more types of flame resistant and/or flame retardant fibers described herein, may independently comprise one type of flame resistant and/or flame retardant fiber described herein, and/or may lack the flame resistant and/or flame retardant fibers described herein.

In some embodiments, a backer comprises flame resistant and/or flame retardant fibers in a relatively large amount. For instance, flame resistant and/or flame retardant fibers may make up greater than or equal to 0 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 75 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the backer. In some embodiments, a backer comprises flame resistant and/or flame retardant fibers that make up less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 75 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 10 wt % of the backer. Combinations of the above-referenced ranges are also possible (e.g., greater than or equal to 0 wt % and less than or equal to 100 wt %, greater than or equal to 50 wt % and less than or equal to 100 wt %, or greater than or equal to 90 wt % and less than or equal to 100 wt %). Other ranges are also possible. In some embodiments, 100 wt % of the backer is made up of flame retardant fibers. In some embodiments, 0 wt % of the backer is made up of flame retardant fibers.

In embodiments in which a backer comprises one or more type of flame resistant and/or flame retardant fiber, each type of flame resistant and/or flame retardant fiber may independently make up a wt % of the backer in one or more of the ranges described above, all of the flame resistant fibers may together make up a wt % of the backer in one or more of the ranges described above, all of the flame retardant fibers may together make up a wt % of the backer in one or more of the ranges described above, and/or all of the flame resistant and flame retardant fibers may together may make up a wt % of the backer in one or more of the ranges described above.

The fibers in the backer may have a variety of suitable average diameters. In some embodiments, a backer comprises fibers having an average fiber diameter of greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 35 microns, greater than or equal to 40 microns, greater than or equal to 45 microns, greater than or equal to 50 microns, greater than or equal to 55 microns, greater than or equal to 60 microns, greater than or equal to 65 microns, or greater than or equal to 70 microns. In some embodiments, a backer comprises fibers having an average fiber diameter of less than or equal to 75 microns, less than or equal to 70 microns, less than or equal to 65 microns, less than or equal to 60 microns, less than or equal to 55 microns, less than or equal to 50 microns, less than or equal to 45 microns, less than or equal to 40 microns, less than or equal to 35 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 14 microns, less than or equal to 13 microns, less than or equal to 12 microns, less than or equal to 11 microns, less than or equal to 10 microns, less than or equal to 9 microns, or less than or equal to 8 microns. Combinations of the above-referenced ranges are also possible (e.g., greater than or equal to 7 microns and less than or equal to 75 microns, greater than or equal to 10 microns and less than or equal to 60 microns, or greater than or equal to 14 microns and less than or equal to 45 microns). Other ranges are also possible.

In embodiments in which a backer comprises two or more types of fibers, each type of fiber may independently have an average fiber diameter in one or more of the ranges described above and/or all of the fibers in the backer may have an average fiber diameter in one or more of the ranges described above. Similarly, in embodiments in which a filter media comprises two or more backers, each backer may independently comprise one or more types of fibers having an average fiber diameter in one or more of the ranges described above and/or may have an average fiber diameter of all of the fibers therein in one or more of the ranges described above.

The lengths of the fibers in a backer may generally be selected as desired. In some embodiments, a backer comprises staple fibers. For instance, the backer may comprise fibers having an average fiber length of greater than or equal to 0.5 in, greater than or equal to 0.75 in, greater than or equal to 1 in, greater than or equal to 1.25 in, greater than or equal to 1.5 in, greater than or equal to 1.75 in, greater than or equal to 2 in, greater than or equal to 2.25 in, greater than or equal to 2.5 in, greater than or equal to 2.75 in, greater than or equal to 3 in, greater than or equal to 3.5 in, greater than or equal to 4 in, or greater than or equal to 4.5 in. In some embodiments, a backer comprises fibers having an average fiber length of less than or equal to 5 in, less than or equal to 4.5 in, less than or equal to 4 in, less than or equal to 3.5 in, less than or equal to 3 in, less than or equal to 2.75 in, less than or equal to 2.5 in, less than or equal to 2.25 in, less than or equal to 2 in, less than or equal to 1.75 in, less than or equal to 1.5 in, less than or equal to 1.25 in, less than or equal to 1 in, or less than or equal to 0.75 in. Combinations of the above-referenced ranges are also possible (e.g., greater than or equal to 0.5 in and less than or equal to 5 in, greater than or equal to 1 in and less than or equal to 4 in, or greater than or equal to 1.25 in and less than or equal to 3 in). Other ranges are also possible. In some embodiments, a backer comprises continuous fibers (e.g., fibers having a length in excess of 5 in).

In embodiments in which a backer comprises two or more types of fibers, each type of fiber may independently have an average fiber length in one or more of the ranges described above and/or all of the fibers in the backer may have an average fiber length in one or more of the ranges described above. Similarly, in embodiments in which a filter media comprises two or more backers, each backer may independently comprise one or more types of fibers having an average fiber length in one or more of the ranges described above and/or may have an average fiber length of all of the fibers therein in one or more of the ranges described above.

In some embodiments, a relatively large wt % of the fibers in a backer and/or a relatively large wt % of the staple fibers in the backer may have a length in one or more of the ranges for average fiber length described above (e.g., of greater than or equal to 0.5 in and less than or equal to 5 in, of greater than or equal to 1 in and less than or equal to 4 in, of greater than or equal to 1.25 in and less than or equal to 3 in). For instance, in some embodiments, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the fibers in a backer and/or the staple fibers in a backer may have a length in one or more of the ranges for average fiber length described above. In some embodiments, less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, or less than or equal to 55 wt % of the fibers in a backer and/or the staple fibers in a backer may have a length in one or more of the ranges for average fiber length described above. Combinations of the above-referenced ranges are also possible (e.g., greater than or equal to 50 wt % and less than or equal to 100 wt %, greater than or equal to 70 wt % and less than or equal to 100 wt %, or greater than or equal to 90 wt % and less than or equal to 100 wt %). Other ranges are also possible.

In embodiments in which a backer comprises two or more types of fibers, each type of fiber may independently have a wt % of fibers having a fiber length in the relevant range in one or more of the ranges described above. By way of example, in some embodiments, a backer comprises staple fibers having a wt % of fibers having a fiber length in the relevant range in one or more of the ranges described above. In some embodiments, all of the fibers in the backer may have a wt % of fibers having a fiber length in the relevant range in one or more of the ranges described above. Similarly, in embodiments in which a filter media comprises two or more backers, each backer may independently comprise one or more types of fibers having a wt % of fibers having a fiber length in the relevant range in one or more of the ranges described above. Additionally, in some embodiments in which a filter media comprises two or more backers, a wt % of all of the fibers therein have a fiber length in the relevant range may be in one or more of the ranges described above.

In some embodiments, a backer comprises fibers that are crimped. As known to those of ordinary skill in the art, crimped fibers comprise one or more undulations, one or more bends, and/or one or more waves that extend along at least a portion of the fiber as a whole (in other words, at least a portion of the fiber has a structure that, as a whole, is undulated, bent, and/or waved). The undulation(s), bend(s), and/or wave(s) may comprise undulation(s), bend(s), and/or wave(s) that are naturally occurring (e.g., undulation(s), bend(s), and/or wave(s) that formed during fiber formation). In some embodiments, the undulation(s), bend(s), and/or wave(s) comprise undulation(s), bend(s), and/or wave(s) that form during chemical processing, mechanical processing and/or thermal processing of the fiber. Crimped fibers typically have a more open structure than uncrimped fibers, and so may enhance the porosity and/or cohesion of fiber webs in which they are positioned.

Crimped fibers present in the backers described herein may have a variety of suitable crimp frequencies. In some embodiments, the crimped fibers have an average crimp frequency of greater than or equal to 1 crimp per inch (CPI), greater than or equal to 1.5 CPI, greater than or equal to 2 CPI, greater than or equal to 2.5 CPI, greater than or equal to 3 CPI, greater than or equal to 3.5 CPI, greater than or equal to 4 CPI, greater than or equal to 5 CPI, greater than or equal to 6 CPI, greater than or equal to 8 CPI, greater than or equal to 10 CPI, greater than or equal to 12.5 CPI, greater than or equal to 15 CPI, greater than or equal to 17.5 CPI, greater than or equal to 20 CPI, greater than or equal to 22.5 CPI, greater than or equal to 25 CPI, or greater than or equal to 27.5 CPI. In some embodiments, the crimped fibers have an average crimp frequency of less than or equal to 30 CPI, less than or equal to 27.5 CPI, less than or equal to 25 CPI, less than or equal to 22.5 CPI, less than or equal to 20 CPI, less than or equal to 17.5 CPI, less than or equal to 15 CPI, less than or equal to 12.5 CPI, less than or equal to 10 CPI, less than or equal to 8 CPI, less than or equal to 6 CPI, less than or equal to 5 CPI, less than or equal to 4 CPI, less than or equal to 3.5 CPI, less than or equal to 3 CPI, less than or equal to 2.5 CPI, less than or equal to 2 CPI, or less than or equal to 1.5 CPI. Combinations of the above-referenced ranges are also possible (e.g., greater than or equal to 1 CPI and less than or equal to 30 CPI, greater than or equal to 2 CPI and less than or equal to 20 CPI, or greater than or equal to 4 CPI and less than or equal to 15 CPI). Other ranges are also possible.

In embodiments in which a backer comprises two or more types of crimped fibers, each type of crimped fiber may independently have an average crimp frequency in one or more of the ranges described above and/or all of the crimped fibers in the backer may together have an average crimp frequency in one or more of the ranges described above. Similarly, in embodiments in which a filter media comprises two or more backers, each backer may independently comprise one or more types of crimped fibers having an average crimp frequency in one or more of the ranges described above and/or all of the crimped fibers therein may together have an average crimp frequency in one or more of the ranges described above.

In some embodiments, a relatively large wt % of the fibers in a backer may have a crimp frequency in one or more of the ranges for average crimp frequency described above (e.g., of greater than or equal to 1 CPI and less than or equal to 30 CPI, greater than or equal to 1 CPI and less than or equal to 10 CPI, of greater than or equal to 2 CPI and less than or equal to 20 CPI, or of greater than or equal to 4 CPI and less than or equal to 15 CPI). For instance, in some embodiments, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, greater than or equal to 92.5 wt %, greater than or equal to 95 wt %, greater than or equal to 97.5 wt %, or greater than or equal to 99 wt % of the fibers in a backer may have a crimp frequency in one or more of the ranges for average crimp frequency described above. In some embodiments, less than or equal to 100 wt %, less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, or less than or equal to 55 wt % of the fibers in a backer may have a crimp frequency in one or more of the ranges for average crimp frequency described above. Combinations of the above-referenced ranges are also possible (e.g., greater than or equal to 50 wt % and less than or equal to 100 wt %, greater than or equal to 70 wt % and less than or equal to 100 wt %, or greater than or equal to 90 wt % and less than or equal to 100 wt %). Other ranges are also possible.

In embodiments in which a backer comprises two or more types of fibers, each type of fiber may independently have a wt % of fibers having a crimp frequency in the relevant range in one or more of the ranges described above and/or all of the fibers in the backer may have a wt % of fibers having a crimp frequency in the relevant range in one or more of the ranges described above. Similarly, in embodiments in which a filter media comprises two or more backers, each backer may independently comprise one or more types of fibers having a wt % of fibers having a crimp frequency in the relevant range in one or more of the ranges described above and/or a wt % of all of the fibers therein having a crimp frequency in the relevant range may be in one or more of the ranges described above.

In some embodiments, a backer comprises a resin. The resin may adhere together the fibers in the backer and/or increase the strength and/or stiffness of the backer. In some embodiments, a backer comprises a resin that coats the fibers therein. When present, the resin may comprise a polymer, such as a thermoplastic polymer and/or a thermoset polymer. Non-limiting examples of suitable materials that may be included in a resin include poly(ester)s, poly(olefin)s, vinyl compounds (e.g., acrylics, styrenated acrylics, vinyl acetates, vinyl acrylics, poly(styrene acrylate), poly(acrylate)s, poly(vinyl alcohol), poly(ethylene vinyl acetate), poly(ethylene vinyl chloride), styrene butadiene rubber, poly(vinyl chloride), poly(vinyl alcohol) derivatives), poly(urethane), poly(amide)s, poly(nitrile)s, elastomers, natural rubber, urea formaldehyde, melamine formaldehyde, phenol formaldehyde, starch, and reaction products thereof. In some embodiments, a resin may further comprise a crosslinking agent. Suitable examples of crosslinking agents include those described elsewhere herein with respect to adhesives. Further examples of materials that may be included in the backers described herein include flame retardants (e.g., as described elsewhere herein), emulsifiers, surfactants, preservatives, fungicides, and antimicrobial additives.

In embodiments in which a filter media comprises two or more backers, each backer may independently comprise a resin comprising one or more of the types of materials described above.

A resin may be included in a backer in a variety of suitable amounts. In some embodiments, resin makes up greater than or equal to 5 wt %, greater than or equal to 6 wt %, greater than or equal to 8 wt %, greater than or equal to 10 wt %, greater than or equal to 12.5 wt %, greater than or equal to 15 wt %, greater than or equal to 17.5 wt %, greater than or equal to 20 wt %, greater than or equal to 25 wt %, greater than or equal to 30 wt %, greater than or equal to 35 wt %, greater than or equal to 40 wt %, or greater than or equal to 45 wt %. In some embodiments, resin makes up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 17.5 wt %, less than or equal to 15 wt %, less than or equal to 12.5 wt %, less than or equal to 10 wt %, less than or equal to 8 wt %, or less than or equal to 6 wt % of the backer. Combinations of the above-referenced ranges are also possible (e.g., greater than or equal to 5 wt % and less than or equal to 50 wt %, greater than or equal to 10 wt % and less than or equal to 45 wt %, greater than or equal to 15 wt % and less than or equal to 35 wt %, or greater than or equal to 10 wt % and less than or equal to 30 wt %). Other ranges are also possible.

In embodiments in which a backer comprises two or more resins, each resin may independently make up a wt % of the backer in one or more of the ranges described above and/or all of the resins in the backer may together make up a wt % of the backer in one or more of the ranges described above. Similarly, when a filter media comprises two or more backers, each backer may independently comprise one or more resins making up a wt % of the backer in one or more of the ranges described above and/or all of the resins may together make up a wt % of each backer in one or more of the ranges described above.

Some resins suitable for inclusion in the backers described herein comprise one or more poly(ester)s in a relatively high amount. For instance, in some embodiments, a poly(ester) makes up greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 92.5 wt %, greater than or equal to 95 wt %, greater than or equal to 97.5 wt %, or greater than or equal to 99 wt % of a resin. In some embodiments, a poly(ester) makes up less than or equal to 100 wt %, less than or equal to 99 wt %, less than or equal to 97.5 wt %, less than or equal to 95 wt %, less than or equal to 92.5 wt %, less than or equal to 90 wt %, less than or equal to 80 wt %, less than or equal to 70 wt %, less than or equal to 60 wt %, less than or equal to 50 wt %, less than or equal to 40 wt %, or less than or equal to 30 wt % of a resin. Combinations of the above-referenced ranges are also possible (e.g., greater than or equal to 20 wt % and less than or equal to 100 wt %, greater than or equal to 50 wt % and less than or equal to 100 wt %, or greater than or equal to 90 wt % and less than or equal to 100 wt %). Other ranges are also possible. The wt % of a poly(ester) in a resin may be determined by nuclear magnetic resonance.

In embodiments in which a backer comprises two or more types of resin, each type of resin may independently make up a wt % of the backer in one or more of the ranges described above and/or all of the resins in the backer may together make up a wt % of the backer in one or more of the ranges described above. Similarly, in embodiments in which a filter media comprises two or more backers, each backer may independently comprise one or more types of resin having making up a wt % of the backer in one or more of the ranges described above and/or all of the resins therein may together make up a wt % of the backer in one or more of the ranges described above.

The resin (if present) may be added to a backer in any suitable manner including, for example, in the presence of a fluid (e.g., in the wet state) or in the absence of a fluid (e.g., in the dry state). In some embodiments, the resin is applied to the backer as a latex dispersed in a dispersion media. The dispersion media may further dissolve and/or suspend one or more additional components of the resin, such as a foaming agent. The backer itself (e.g., the fibers therein) may be wet or may be dry. A variety of suitable methods and equipment may be employed to introduce the resin into the backer. By way of example, a resin may be added to a backer by curtain coating, gravure coating (e.g., roto-gravure coating), melt coating, dip coating, knife roll coating, and/or spin coating. Further examples of suitable processes include those employing a foam bath, a pad mangle, a spray saturator, and/or a size press. In some embodiments, one or more components of the backer (e.g., at least a portion of the fibers therein) precipitates the resin upon exposure thereto. For example, the backer may comprise a precipitating agent (e.g., epichlorohydrin). In some embodiments, a resin is added to a backer in a manner such that the backer becomes saturated with the resin (e.g., in a manner such that the resin permeates throughout the backer).

When applied to a backer in the presence of a fluid (e.g., in a wet state), the resin typically comprises one or more fluids (e.g., one or more dispersion media, one or more solvents) and one or more solids suspended and/or dissolved therein. The fluids may comprise organic fluids and/or aqueous fluids. Typically, the fluids are evaporated from the resin during further manufacturing steps, and the resultant resin in the final filter media is a solid (e.g., it may comprise solids present in the fluid-comprising and/or wet state resin and/or reaction products thereof). Solids may make up a variety of suitable amounts of resins that further comprise a fluid (e.g., wet state resins). In some embodiments, solids make up greater than or equal to 5 wt %, greater than or equal to 6 wt %, greater than or equal to 7 wt %, greater than or equal to 8 wt %, greater than or equal to 10 wt %, greater than or equal to 12.5 wt %, greater than or equal to 15 wt %, greater than or equal to 17.5 wt %, greater than or equal to 20 wt %, greater than or equal to 25 wt %, greater than or equal to 30 wt %, greater than or equal to 35 wt %, greater than or equal to 40 wt %, or greater than or equal to 45 wt % of a resin further comprising a fluid and suitable for use in the backers described herein. In some embodiments, solids make up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 17.5 wt %, less than or equal to 15 wt %, less than or equal to 12.5 wt %, less than or equal to 10 wt %, less than or equal to 8 wt %, less than or equal to 7 wt %, or less than or equal to 6 wt % of a resin further comprising a fluid and suitable for use in the backers described herein. Combinations of the above-referenced ranges are also possible (e.g., greater than or equal to 5 wt % and less than or equal to 50 wt %, or greater than or equal to 8 wt % and less than or equal to 25 wt %). Other ranges are also possible.

In some embodiments, one or more poly(ester)s make up a relatively large wt % of a backer as a whole. For instance, the total poly(ester) content in the backer may be greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 92.5 wt %, greater than or equal to 95 wt %, greater than or equal to 97.5 wt %, or greater than or equal to 99 wt % of the backer as a whole. In some embodiments, the total poly(ester) content in the backer is less than or equal to 100 wt %, less than or equal to 99 wt %, less than or equal to 97.5 wt %, less than or equal to 95 wt %, less than or equal to 92.5 wt %, less than or equal to 90 wt %, less than or equal to 80 wt %, less than or equal to 70 wt %, less than or equal to 60 wt %, less than or equal to 50 wt %, less than or equal to 40 wt %, or less than or equal to 30 wt % of the backer as a whole. Combinations of the above-referenced ranges are also possible (e.g., greater than or equal to 20 wt % and less than or equal to 100 wt %, greater than or equal to 50 wt % and less than or equal to 100 wt %, or greater than or equal to 90 wt % and less than or equal to 100 wt %). Other ranges are also possible. The wt % of a poly(ester) in a backer may be determined by nuclear magnetic resonance.

It should be understood that backers comprising a variety of suitable components may have a wt % of poly(ester) in one or more of the above-referenced ranges. For instance, in some embodiments, a backer comprises both a resin comprising one or more poly(ester)s and fibers comprising one or more poly(ester)s, and the total amount of poly(ester) in the resin and fibers together may be in one or more of the ranges described above. As another example, a backer comprising a resin comprising a poly(ester) but lacking fibers comprising poly(ester) may have a wt % of poly(ester) in one or more of the above-referenced ranges. As a third example, a backer comprising fibers comprising a poly(ester) but lacking a resin comprising poly(ester) may have a wt % of poly(ester) in one or more of the above-referenced ranges. It should also be understood that, in filter media comprising one or more backers, each backer may independently have an amount of poly(ester) in one or more of the above-referenced ranges.

The backers described herein may have a variety of suitable initial dioctyl phthalate (DOP) penetrations at 0.33 microns and initial air resistances. Penetration, often expressed as a percentage, is defined as follows: Pen (%)=(C/C₀)*100% where C is the particle concentration after passage through the backer and C₀ is the particle concentration before passage through the backer. The initial penetration for 0.33 micron DOP particles may be measured by blowing DOP particles through a backer and measuring the percentage of particles that penetrate therethrough. This may be accomplished by use of a TSI 8130 automated filter testing unit from TSI, Inc. equipped with a dioctyl phthalate generator for DOP aerosol testing for 0.33 micron DOP particles. The TSI 8130 automated filter testing unit may be employed to perform an automated procedure entitled “Filter Test” encoded by the software therein for 0.33 micron particles at a face velocity of 5.33 cm/s. Briefly, this test comprises blowing DOP particles with an average particle diameter of 0.33 microns at a 100 cm² face area of the upstream face of the backer. The upstream and downstream particle concentrations may be measured by use of condensation particle counters. During the penetration measurement, the 100 cm² face area of the upstream face of the backer may be subject to a continuous flow of DOP particles at a media face velocity of 5.33 cm/s until the penetration reading is determined to be stable by the TSI 8130 automated filter testing unit. The initial air resistance of the backer may also be measured concurrently with the initial DOP penetration at 0.33 microns while following this same procedure.

The initial DOP penetration at 0.33 microns for a backers may be greater than or equal to 75%, greater than or equal to 77.5%, greater than or equal to 80%, greater than or equal to 82.5%, greater than or equal to 85%, greater than or equal to 87.5%, greater than or equal to 90%, greater than or equal to 92.5%, greater than or equal to 95%, greater than or equal to 97%, greater than or equal to 98%, or greater than or equal to 99%. The initial DOP penetration at 0.33 microns for a backer may be less than or equal to 100%, less than or equal to 99%, less than or equal to 98%, less than or equal to 97%, less than or equal to 95%, less than or equal to 92.5%, less than or equal to 90%, less than or equal to 87.5%, less than or equal to 85%, less than or equal to 82.5%, less than or equal to 80%, or less than or equal to 77.5%. Combinations of the above-referenced ranges are also possible (e.g., greater than or equal to 75% and less than or equal to 100%, greater than or equal to 75% and less than or equal to 99%, greater than or equal to 80% and less than or equal to 98%, or greater than or equal to 85% and less than or equal to 97%). Other ranges are also possible.

In embodiments in which a filter media comprises two or more backers, each backer may independently have an initial DOP penetration at 0.33 microns in one or more of the above-referenced ranges.

The initial air resistance of a backer may be greater than or equal to 0.05 mm H₂O, greater than or equal to 0.06 mm H₂O, greater than or equal to 0.07 mm H₂O, greater than or equal to 0.08 mm H₂O, greater than or equal to 0.09 mm H₂O, greater than or equal to 0.1 mm H₂O, greater than or equal to 0.15 mm H₂O, greater than or equal to 0.2 mm H₂O, greater than or equal to 0.25 mm H₂O, greater than or equal to 0.3 mm H₂O, greater than or equal to 0.35 mm H₂O, greater than or equal to 0.4 mm H₂O, greater than or equal to 0.5 mm H₂O, greater than or equal to 0.6 mm H₂O, greater than or equal to 0.7 mm H₂O, greater than or equal to 0.8 mm H₂O, or greater than or equal to 0.9 mm H₂O. The initial air resistance of a backer may be less than or equal to 1 mm H₂O, less than or equal to 0.9 mm H₂O, less than or equal to 0.8 mm H₂O, less than or equal to 0.7 mm H₂O, less than or equal to 0.6 mm H₂O, less than or equal to 0.5 mm H₂O, less than or equal to 0.4 mm H₂O, less than or equal to 0.35 mm H₂O, less than or equal to 0.3 mm H₂O, less than or equal to 0.25 mm H₂O, less than or equal to 0.2 mm H₂O, less than or equal to 0.15 mm H₂O, less than or equal to 0.1 mm H₂O, less than or equal to 0.09 mm H₂O, less than or equal to 0.08 mm H₂O, less than or equal to 0.07 mm H₂O, or less than or equal to 0.06 mm H₂O. Combinations of the above-referenced ranges are also possible (e.g., greater than or equal to 0.05 mm H₂O and less than or equal to 1 mm H₂O, greater than or equal to 0.07 mm H₂O and less than or equal to 0.7 mm H₂O, or greater than or equal to 0.1 mm H₂O and less than or equal to 0.4 mm H₂O). Other ranges are also possible.

In embodiments in which a filter media comprises two or more backers, each backer may independently have an air resistance in one or more of the above-referenced ranges.

In some embodiments, a backer has a relatively high stiffness in the machine direction. A backer may have a stiffness in the machine direction of greater than or equal to 100 mg, greater than or equal to 125 mg, greater than or equal to 150 mg, greater than or equal to 175 mg, greater than or equal to 200 mg, greater than or equal to 225 mg, greater than or equal to 250 mg, greater than or equal to 275 mg, greater than or equal to 300 mg, greater than or equal to 350 mg, greater than or equal to 400 mg, greater than or equal to 500 mg, greater than or equal to 600 mg, greater than or equal to 700 mg, greater than or equal to 800 mg, greater than or equal to 900 mg, greater than or equal to 950 mg, greater than or equal to 1000 mg, greater than or equal to 1250 mg, greater than or equal to 1500 mg, or greater than or equal to 1750 mg. In some embodiments, a backer has a stiffness in the machine direction of less than or equal to 2000 mg, less than or equal to 1750 mg, less than or equal to 1500 mg, less than or equal to 1250 mg, less than or equal to 1000 mg, less than or equal to 950 mg, less than or equal to 900 mg, less than or equal to 800 mg, less than or equal to 700 mg, less than or equal to 600 mg, less than or equal to 500 mg, less than or equal to 400 mg, less than or equal to 350 mg, less than or equal to 300 mg, less than or equal to 275 mg, less than or equal to 250 mg, less than or equal to 225 mg, less than or equal to 200 mg, less than or equal to 175 mg, less than or equal to 150 mg, or less than or equal to 125 mg. Combinations of the above-referenced ranges are also possible (e.g., greater than or equal to 100 mg and less than or equal to 2000 mg, greater than or equal to 150 mg and less than or equal to 1000 mg, or greater than or equal to 200 mg and less than or equal to 900 mg). Other ranges are also possible. The stiffness of a backer in the machine direction may be determined in accordance with TAPPI T543 om-05 (2005) using a sample size of 2 in×2.5 in.

In embodiments in which a filter media comprises two or more backers, each backer may independently have a stiffness in the machine direction in one or more of the above-referenced ranges.

In some embodiments, a backer has a relatively high stiffness in the cross direction. A backer may have a stiffness in the cross direction of greater than or equal to 45 mg, greater than or equal to 50 mg, greater than or equal to 55 mg, greater than or equal to 60 mg, greater than or equal to 65 mg, greater than or equal to 70 mg, greater than or equal to 75 mg, greater than or equal to 80 mg, greater than or equal to 90 mg, greater than or equal to 100 mg, greater than or equal to 125 mg, greater than or equal to 150 mg, greater than or equal to 175 mg, greater than or equal to 200 mg, greater than or equal to 250 mg, greater than or equal to 300 mg, greater than or equal to 350 mg, greater than or equal to 400 mg, greater than or equal to 450 mg, greater than or equal to 500 mg, greater than or equal to 525 mg, greater than or equal to 550 mg, greater than or equal to 575 mg, greater than or equal to 600 mg, greater than or equal to 700 mg, greater than or equal to 800 mg, greater than or equal to 900 mg, greater than or equal to 950 mg, greater than or equal to 1000 mg, greater than or equal to 1250 mg, greater than or equal to 1500 mg, or greater than or equal to 1750 mg. A backer may have a stiffness in the cross direction of less than or equal to 2000 mg, less than or equal to 1750 mg, less than or equal to 1500 mg, less than or equal to 1250 mg, less than or equal to 1000 mg, less than or equal to 950 mg, less than or equal to 900 mg, less than or equal to 800 mg, less than or equal to 700 mg, less than or equal to 600 mg, less than or equal to 575 mg, less than or equal to 550 mg, less than or equal to 525 mg, less than or equal to 500 mg, less than or equal to 450 mg, less than or equal to 400 mg, less than or equal to 350 mg, less than or equal to 300 mg, less than or equal to 250 mg, less than or equal to 200 mg, less than or equal to 175 mg, less than or equal to 150 mg, less than or equal to 125 mg, less than or equal to 100 mg, less than or equal to 90 mg, less than or equal to 80 mg, less than or equal to 75 mg, less than or equal to 70 mg, less than or equal to 65 mg, less than or equal to 60 mg, less than or equal to 55 mg, or less than or equal to 50 mg. Combinations of the above-referenced ranges are also possible (e.g., greater than or equal to 45 mg and less than or equal to 2000 mg, greater than or equal to 45 mg and less than or equal to 600 mg, greater than or equal to 60 mg and less than or equal to 550 mg, or greater than or equal to 75 mg and less than or equal to 500 mg). Other ranges are also possible. The stiffness of a backer in the cross direction may be determined in accordance with TAPPI T543 om-94 using a sample size of 2 in×2.5 in.

In embodiments in which a filter media comprises two or more backers, each backer may independently have a stiffness in the cross direction in one or more of the above-referenced ranges.

The backers described herein may have relatively high values of dry tensile strength in the machine direction. In some embodiments, a backer has a dry tensile strength in the machine direction of greater than or equal to 10 lbs/in, greater than or equal to 11 lbs/in, greater than or equal to 12 lbs/in, greater than or equal to 13 lbs/in, greater than or equal to 14 lbs/in, greater than or equal to 15 lbs/in, greater than or equal to 16 lbs/in, greater than or equal to 17 lbs/in, greater than or equal to 18 lbs/in, greater than or equal to 20 lbs/in, greater than or equal to 22 lbs/in, greater than or equal to 24 lbs/in, greater than or equal to 26 lbs/in, greater than or equal to 28 lbs/in, greater than or equal to 30 lbs/in, greater than or equal to 32.5 lbs/in, greater than or equal to 35 lbs/in, greater than or equal to 37.5 lbs/in, greater than or equal to 40 lbs/in, or greater than or equal to 42.5 lbs/in. In some embodiments, a backer has a dry tensile strength in the machine direction of less than or equal to 45 lbs/in, less than or equal to 42.5 lbs/in, less than or equal to 40 lbs/in, less than or equal to 37.5 lbs/in, less than or equal to 35 lbs/in, less than or equal to 32.5 lbs/in, less than or equal to 30 lbs/in, less than or equal to 28 lbs/in, less than or equal to 26 lbs/in, less than or equal to 24 lbs/in, less than or equal to 22 lbs/in, less than or equal to 20 lbs/in, less than or equal to 18 lbs/in, less than or equal to 17 lbs/in, less than or equal to 16 lbs/in, less than or equal to 15 lbs/in, less than or equal to 14 lbs/in, less than or equal to 13 lbs/in, less than or equal to 12 lbs/in, or less than or equal to 11 lbs/in. Combinations of the above-referenced ranges are also possible (e.g., greater than or equal to 10 lbs/in and less than or equal to 45 lbs/in, greater than or equal to 14 lbs/in and less than or equal to 35 lbs/in, or greater than or equal to 18 lbs/in and less than or equal to 28 lbs/in). Other ranges are also possible. The dry tensile strength in the machine direction of a backer may be determined in accordance with T494 om-96 using a test span of 4 in and a jaw separation speed of 1 in/min.

In embodiments in which a filter media comprises two or more backers, each backer may independently have a dry tensile strength in the machine direction in one or more of the above-referenced ranges.

In some embodiments, a backer has a relatively high dry tensile strength in the cross direction. The backer may have a dry tensile strength in the cross direction of greater than or equal to 2 lbs/in, greater than or equal to 2.5 lbs/in, greater than or equal to 3 lbs/in, greater than or equal to 3.5 lbs/in, greater than or equal to 4 lbs/in, greater than or equal to 4.5 lbs/in, greater than or equal to 5 lbs/in, greater than or equal to 6 lbs/in, greater than or equal to 7 lbs/in, greater than or equal to 8 lbs/in, greater than or equal to 9 lbs/in, greater than or equal to 10 lbs/in, or greater than or equal to 11 lbs/in. The backer may have a dry tensile strength in the cross direction of less than or equal to 12 lbs/in, less than or equal to 11 lbs/in, less than or equal to 10 lbs/in, less than or equal to 9 lbs/in less than or equal to 8 lbs/in, less than or equal to 7 lbs/in, less than or equal to 6 lbs/in, less than or equal to 5 lbs/in, less than or equal to 4.5 lbs/in, less than or equal to 4 lbs/in, less than or equal to 3.5 lbs/in, less than or equal to 3 lbs/in, or less than or equal to 2.5 lbs/in. Combinations of the above-referenced ranges are also possible (e.g., greater than or equal to 2 lbs/in and less than or equal to 12 lbs/in, greater than or equal to 3 lbs/in and less than or equal to 10 lbs/in, or greater than or equal to 4 lbs/in and less than or equal to 8 lbs/in). Other ranges are also possible. The dry tensile strength in the cross direction of a backer may be determined in accordance with T494 om-96 using a test span of 4 in and a jaw separation speed of 1 in/min.

In embodiments in which a filter media comprises two or more backers, each backer may independently have a dry tensile strength in the cross direction in one or more of the above-referenced ranges.

A backer may have a variety of suitable ratios of dry tensile strength in the machine direction to dry tensile strength in the cross direction. In some embodiments, the ratio of dry tensile strength in the machine direction to dry tensile strength in the cross direction for a backer is greater than or equal to 1.5, greater than or equal to 1.75, greater than or equal to 2, greater than or equal to 2.25, greater than or equal to 2.5, greater than or equal to 2.75, greater than or equal to 3, greater than or equal to 3.25, greater than or equal to 3.5, greater than or equal to 4, greater than or equal to 4.5, greater than or equal to 5, greater than or equal to 6, greater than or equal to 7, greater than or equal to 8, greater than or equal to 9, greater than or equal to 10, greater than or equal to 11, greater than or equal to 12, greater than or equal to 13, or greater than or equal to 14. In some embodiments, the ratio of dry tensile strength in the machine direction to dry tensile strength in the cross direction for a backer is less than or equal to 15, less than or equal to 14, less than or equal to 13, less than or equal to 12, less than or equal to 11, less than or equal to 10, less than or equal to 9, less than or equal to 8, less than or equal to 7, less than or equal to 6, less than or equal to 5, less than or equal to 4.5, less than or equal to 4, less than or equal to 3.5, less than or equal to 3.25, less than or equal to 3, less than or equal to 2.75, less than or equal to 2.5, less than or equal to 2.25, less than or equal to 2, or less than or equal to 1.75. Combinations of the above-referenced ranges are also possible (e.g., greater than or equal to 1.5 and less than or equal to 15, greater than or equal to 2 and less than or equal to 10, or greater than or equal to 3 and less than or equal to 6). Other ranges are also possible.

In embodiments in which a filter media comprises two or more backers, each backer may independently have a ratio of dry tensile strength in the machine direction to dry tensile strength in the cross direction in one or more of the above-referenced ranges.

The backers described herein may have a variety of suitable basis weights. In some embodiments, a backer has a basis weight of greater than or equal to 20 gsm, greater than or equal to 25 gsm, greater than or equal to 30 gsm, greater than or equal to 35 gsm, greater than or equal to 40 gsm, greater than or equal to 45 gsm, greater than or equal to 50 gsm, greater than or equal to 60 gsm, greater than or equal to 80 gsm, greater than or equal to 100 gsm, greater than or equal to 120 gsm, greater than or equal to 150 gsm, greater than or equal to 175 gsm, greater than or equal to 200 gsm, or greater than or equal to 250 gsm. In some embodiments, a backer has a basis weight of less than or equal to 300 gsm, less than or equal to 250 gsm, less than or equal to 200 gsm, less than or equal to 175 gsm, less than or equal to 150 gsm, less than or equal to 120 gsm, less than or equal to 100 gsm, less than or equal to 80 gsm, less than or equal to 60 gsm, less than or equal to 50 gsm, less than or equal to 45 gsm, less than or equal to 40 gsm, less than or equal to 35 gsm, less than or equal to 30 gsm, or less than or equal to 25 gsm. Combinations of the above-referenced ranges are also possible (e.g., greater than or equal to 20 gsm and less than or equal to 300 gsm, greater than or equal to 30 gsm and less than or equal to 200 gsm, or greater than or equal to 50 gsm and less than or equal to 120 gsm). The basis weight of a backer may be determined in accordance with ISO 536:2012.

In embodiments in which a filter media comprises two or more backers, each backer may independently have a basis weight in one or more of the above-referenced ranges.

The thickness of a backer may generally be selected as desired. In some embodiments, a backer has a thickness of greater than or equal to 0.1 mm, greater than or equal to 0.125 mm, greater than or equal to 0.15 mm, greater than or equal to 0.175 mm, greater than or equal to 0.2 mm, greater than or equal to 0.225 mm, greater than or equal to 0.25 mm, greater than or equal to 0.3 mm, greater than or equal to 0.4 mm, greater than or equal to 0.5 mm, greater than or equal to 0.6 mm, greater than or equal to 0.75 mm, greater than or equal to 1 mm, greater than or equal to 1.1 mm, greater than or equal to 1.25 mm, greater than or equal to 1.4 mm, greater than or equal to 1.5 mm, greater than or equal to 1.6 mm, or greater than or equal to 1.8 mm. In some embodiments, a backer has a thickness of less than or equal to 2 mm, less than or equal to 1.8 mm, less than or equal to 1.6 mm, less than or equal to 1.5 mm, less than or equal to 1.4 mm, less than or equal to 1.25 mm, less than or equal to 1.1 mm, less than or equal to 1 mm, less than or equal to 0.75 mm, less than or equal to 0.6 mm, less than or equal to 0.5 mm, less than or equal to 0.4 mm, less than or equal to 0.3 mm, less than or equal to 0.2 mm, less than or equal to 0.175 mm, less than or equal to 0.15 mm, or less than or equal to 0.125 mm. Combinations of the above-referenced ranges are also possible (e.g., greater than or equal to 0.1 mm and less than or equal to 2 mm, greater than or equal to 0.2 mm and less than or equal to 1.25 mm, or greater than or equal to 0.25 m and less than or equal to 0.75 mm). The thickness of a backer may be determined in accordance with ASTM D1777 (2015) under an applied pressure of 0.8 kPa.

In embodiments in which a filter media comprises two or more backers, each backer may independently have a thickness in one or more of the above-referenced ranges.

Backers having a variety of solidities are contemplated herein. The solidity of a backer is equivalent to the percentage of the interior of the backer occupied by solid material. One non-limiting way of determining solidity of a backer is described in this paragraph, but other methods are also possible. The method described in this paragraph includes determining the basis weight and thickness of the backer and then applying the following formula: solidity=[basis weight of the backer/(density of the components forming the backer*thickness of the backer)]*100%. The density of the components forming the backer is equivalent to the average density of the material or material(s) forming the components of the backer (e.g., fibers, resin), which is typically specified by the manufacturer of each material. The average density of the materials forming the components of the backer may be determined by: (1) determining the total volume of all of the components in the backer; and (2) dividing the total mass of all of the components in the backer by the total volume of all of the components in the backer. If the mass and density of each component of the backer are known, the volume of all the components in the backer may be determined by: (1) for each type of component, dividing the total mass of the component in the backer by the density of the component; and (2) summing the volumes of each component. If the mass and density of each component of the backer are not known, the volume of all the components in the backer may be determined in accordance with Archimedes' principle.

In some embodiments, a backer has a solidity of greater than or equal to 2%, greater than or equal to 2.5%, greater than or equal to 3%, greater than or equal to 3.5%, greater than or equal to 4%, greater than or equal to 4.5%, greater than or equal to 5%, greater than or equal to 6%, greater than or equal to 8%, greater than or equal to 10%, greater than or equal to 12.5%, greater than or equal to 15%, greater than or equal to 17.5%, greater than or equal to 20%, greater than or equal to 22.5%, greater than or equal to 25%, greater than or equal to 27.5%, greater than or equal to 30%, or greater than or equal to 32.5%. In some embodiments, a backer has a solidity of less than or equal to 35%, less than or equal to 32.5%, less than or equal to 30%, less than or equal to 27.5%, less than or equal to 25%, less than or equal to 22.5%, less than or equal to 20%, less than or equal to 17.5%, less than or equal to 15%, less than or equal to 12.5%, less than or equal to 10%, less than or equal to 8%, less than or equal to 6%, less than or equal to 5%, less than or equal to 4.5%, less than or equal to 4%, less than or equal to 3.5%, less than or equal to 3%, or less than or equal to 2.5%. Combinations of the above-referenced ranges are also possible (e.g., greater than or equal to 2% and less than or equal to 35%, greater than or equal to 3% and less than or equal to 25%, or greater than or equal to 4% and less than or equal to 20%). Other ranges are also possible.

In embodiments in which a filter media comprises two or more backers, each backer may independently have a solidity in one or more of the above-referenced ranges.

When present, a backer may have a variety of suitable air permeabilities. In some embodiments, a backer has an air permeability of greater than or equal to 100 cubic feet per minute per square foot (CFM), greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, greater than or equal to 350 CFM, greater than or equal to 400 CFM, greater than or equal to 500 CFM, greater than or equal to 750 CFM, greater than or equal to 1000 CFM, greater than or equal to 1250 CFM, greater than or equal to 1500 CFM, or greater than or equal to 1800 CFM. In some embodiments, a backer has an air permeability of less than or equal to 2000 CFM, less than or equal to 1800 CFM, less than or equal to 1500 CFM, less than or equal to 1250 CFM, less than or equal to 1000 CFM, less than or equal to 750 CFM, less than or equal to 500 CFM, less than or equal to 400 CFM, less than or equal to 350 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, or less than or equal to 125 CFM. Combinations of the above-referenced ranges are also possible (e.g., greater than or equal to 100 CFM and less than or equal to 2000 CFM, greater than or equal to 200 CFM and less than or equal to 1800 CFM, or greater than or equal to 300 CFM and less than or equal to 1500 CFM). Other ranges are also possible. The air permeability of a backer may be determined in accordance with ASTM D737-04 (2016) at a pressure of 125 Pa.

In embodiments in which a filter media comprises two or more backers, each backer may independently have an air permeability in one or more of the above-referenced ranges.

As described above, some filter media described herein comprise a prefilter. The prefilter may enhance the capacity of the filter media and/or protect one or more components of the filter media (e.g., a fiber web comprising nanofibers). Prefilters are typically positioned upstream of one or more other components of the filter media, such as an efficiency layer. It should be understood that any individual prefilter may independently have some or all of the properties described herein with respect to prefilters.

When present, a prefilter may comprise a non-woven fiber web. The non-woven fiber web may be a meltblown non-woven fiber web, a spunbond non-woven fiber web, a wetlaid non-woven fiber web, an electrospun non-woven fiber web, a centrifugal spun non-woven fiber web, an airlaid non-woven fiber web, and/or a carded non-woven fiber web. Such fiber webs may comprise continuous fibers (e.g., meltblown fibers, spunbond fibers, electrospun fibers, centrifugal spun fibers) or non-continuous fibers.

In embodiments in which a filter media comprises two or more prefilters, each prefilter may independently comprise one of the non-woven fiber webs described above and/or one or more of the types of fibers described above.

In some embodiments, a prefilter comprises synthetic fibers and/or is made up of synthetic fibers (e.g., it may comprise and/or be a synthetic fiber web). For instance, 100 wt % of the fibers in the prefilter may be synthetic fibers and/or synthetic material may make up 100 wt % of the prefilter. In some embodiments, the synthetic fibers are and/or comprise monocomponent fibers. Non-limiting examples of suitable synthetic fibers include fibers comprising one or more of the following materials: poly(ester)s (e.g., poly(ethylene terephthalate), poly(butylene terephthalate)), poly(carbonate), poly(amide)s (e.g., various nylon polymers), poly(aramid)s, poly(imide)s, poly(olefin)s (e.g., poly(ethylene), poly(propylene)), poly(ether ether ketone), poly(acrylic)s (e.g., poly(acrylonitrile)), poly(vinyl alcohol), regenerated cellulose (e.g., synthetic cellulose such cellulose acetate, rayon), fluorinated polymers (e.g., poly(vinylidene difluoride) (PVDF)), copolymers of poly(ethylene) and PVDF, and poly(ether sulfone)s.

The prefilters described herein may include more than one type of fiber (e.g., two or more different types of monocomponent synthetic fibers, such as poly(ethylene) fibers and poly(ester) fibers) or may include exclusively one type of fiber (e.g., exclusively monocomponent synthetic fibers comprising poly(ethylene)). In some embodiments, the fibers in the prefilter comprise fibers comprising a blend of two or more of the polymers listed above (e.g., a blend of two types of poly(ester)).

Fibers in a prefilter (e.g., synthetic fibers) may further comprise one or more additives. For instance, in some embodiments, a prefilter comprises synthetic fibers further comprising a charge-stabilizing additive. The charge-stabilizing additive may be dispersed throughout the fiber (e.g., it may be extruded with a polymeric component to form a fiber comprising both the charge-stabilizing additive and the polymeric component), and/or may be positioned within the fiber in another suitable manner. One example of a suitable class of charge-stabilizing additives is hindered amine light stabilizers. Without wishing to be bound by any particular theory, it is believed that hindered amine light stabilizers are capable accepting and stabilizing charged species (e.g., a positively charged species, such as a proton from water; a negatively charged species) thereon. Further non-limiting examples of suitable charge-stabilizing additives include fused aromatic thioureas, organic triazines, UV stabilizers, phosphites, additives comprising two or more amide groups (e.g., bisamides, trisamides), and stearates (e.g., magnesium stearate, calcium stearate). Charge-stabilizing additives may be incorporated into fibers by forming a continuous fiber from a composition comprising the charge-stabilizing additive.

Further examples of suitable additives that may be included in fibers in the prefilters described herein include fire retardant additives, anti-oxidizing additives, processing aids, and antimicrobial additives.

In embodiments in which a filter media comprises two or more prefilters, each prefilter may independently comprise fibers comprising one or more of the materials described above and/or having one or more of the compositions described above.

Fibers suitable for use in the prefilters described herein may have a variety of average fiber diameters. In some embodiments, a prefilter comprises fibers having an average fiber diameter of greater than or equal to 0.2 microns, greater than or equal to 0.5 microns, greater than or equal to 0.8 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, or greater than or equal to 17.5 microns. In some embodiments, a prefilter comprises fibers having an average fiber diameter of less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.8 microns, or less than or equal to 0.5 microns. Combinations of the above-referenced ranges are also possible (e.g., greater than or equal to 0.2 microns and less than or equal to 20 microns, greater than or equal to 0.2 microns and less than or equal to 10 microns, greater than or equal to 0.8 microns and less than or equal to 8 microns, or greater than or equal to 1 micron and less than or equal to 5 microns). Other ranges are also possible.

In embodiments in which a prefilter comprises two or more types of fibers, each type of fiber may independently have an average fiber diameter in one or more of the ranges described above and/or all of the fibers in the prefilter may together have an average fiber diameter in one or more of the ranges described above. Similarly, when a filter media comprises two or more prefilters, each prefilter may independently comprise one or more types of fibers having an average fiber diameter in one or more of the ranges described above and/or may have an average fiber diameter for all of the fibers therein in one or more of the ranges described above.

Some prefilters may further comprise one or more additional components. By way of example, in some embodiments, a filter media comprises one or more prefilters comprising a resin.

Prefilters may have a range of values of initial DOP penetration at 0.33 microns. In some embodiments, a prefilter has an initial DOP penetration at 0.33 microns of less than or equal to 99%, less than or equal to 98%, less than or equal to 97%, less than or equal to 96%, less than or equal to 95%, less than or equal to 92.5%, less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, less than or equal to 2%, less than or equal to 1%, less than or equal to 0.8%, less than or equal to 0.6%, less than or equal to 0.5%, less than or equal to 0.4%, less than or equal to 0.3%, or less than or equal to 0.2%. In some embodiments, a prefilter has an initial DOP penetration at 0.33 microns of greater than or equal to 0.1%, greater than or equal to 0.2%, greater than or equal to 0.3%, greater than or equal to 0.4%, greater than or equal to 0.5%, greater than or equal to 0.6% greater than or equal to 0.8%, greater than or equal to 1%, greater than or equal to 2%, greater than or equal to 5%, greater than or equal to 7.5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, greater than or equal to 80%, greater than or equal to 90%, greater than or equal to 92.5%, greater than or equal to 95%, greater than or equal to 96%, greater than or equal to 97%, or greater than or equal to 98%. Combinations of the above-referenced ranges are also possible (e.g., less than or equal to 99% and greater than or equal to 0.1%, less than or equal to 95% and greater than or equal to 0.5%, or less than or equal to 90% and greater than or equal to 1%). Other ranges are also possible. The initial DOP penetration at 0.33 microns of a prefilter may be determined in accordance with the use of a TSI 8130 automated filter testing unit from TSI, Inc. equipped with a dioctyl phthalate generator for DOP aerosol testing for 0.33 micron DOP particles as described elsewhere herein.

In embodiments in which a filter media comprises two or more prefilters, each prefilter may independently have an initial DOP penetration at 0.33 microns in one or more of the ranges described above.

In some embodiments, a filter media comprises a prefilter having a relatively low initial air resistance. For instance, a prefilter may have an initial air resistance of less than or equal to 6 mm H₂O, less than or equal to 5.5 mm H₂O, less than or equal to 5 mm H₂O, less than or equal to 4.5 mm H₂O, less than or equal to 4 mm H₂O, less than or equal to 3.5 mm H₂O, less than or equal to 3 mm H₂O, less than or equal to 2.5 mm H₂O, less than or equal to 2 mm H₂O, less than or equal to 1.5 mm H₂O, less than or equal to 1 mm H₂O, less than or equal to 0.8 mm H₂O, less than or equal to 0.6 mm H₂O, less than or equal to 0.5 mm H₂O, less than or equal to 0.4 mm H₂O, less than or equal to 0.35 mm H₂O, less than or equal to 0.3 mm H₂O, less than or equal to 0.25 mm H₂O, less than or equal to 0.2 mm H₂O, or less than or equal to 0.15 mm H₂O. In some embodiments, a prefilter has an initial air resistance of greater than or equal to 0.1 mm H₂O, greater than or equal to 0.15 mm H₂O, greater than or equal to 0.2 mm H₂O, greater than or equal to 0.25 mm H₂O, greater than or equal to 0.3 mm H₂O, greater than or equal to 0.35 mm H₂O, greater than or equal to 0.4 mm H₂O, greater than or equal to 0.5 mm H₂O, greater than or equal to 0.6 mm H₂O, greater than or equal to 0.8 mm H₂O, greater than or equal to 1 mm H₂O, greater than or equal to 1.5 mm H₂O, greater than or equal to 2 mm H₂O, greater than or equal to 2.5 mm H₂O, greater than or equal to 3 mm H₂O, greater than or equal to 3.5 mm H₂O, greater than or equal to 4 mm H₂O, greater than or equal to 4.5 mm H₂O, greater than or equal to 5 mm H₂O, or greater than or equal to 5.5 mm H₂O. Combinations of the above-referenced ranges are also possible (e.g., less than or equal to 6 mm H₂O and greater than or equal to 0.1 mm H₂O, less than or equal to 4 mm H₂O and greater than or equal to 0.3 mm H₂O, or less than or equal to 2 mm H₂O and greater than or equal to 0.5 mm H₂O). Other ranges are also possible. The initial air resistance of a prefilter may be determined concurrently with the initial DOP loading at 0.33 microns as described elsewhere herein.

In embodiments in which a filter media comprises two or more prefilters, each prefilter may independently have an initial air resistance in one or more of the ranges described above.

The prefilters described herein may have a variety of suitable basis weights. In some embodiments, a prefilter has a basis weight of greater than or equal to 1 gsm, greater than or equal to 1.5 gsm, greater than or equal to 2 gsm, greater than or equal to 2.5 gsm, greater than or equal to 3 gsm, greater than or equal to 3.5 gsm, greater than or equal to 4 gsm, greater than or equal to 4.5 gsm, greater than or equal to 5 gsm, greater than or equal to 6 gsm, greater than or equal to 7 gsm, greater than or equal to 8 gsm, greater than or equal to 10 gsm, greater than or equal to 12.5 gsm, greater than or equal to 15 gsm, greater than or equal to 17.5 gsm, greater than or equal to 20 gsm, greater than or equal to 22.5 gsm, greater than or equal to 25 gsm, greater than or equal to 30 gsm, greater than or equal to 35 gsm, greater than or equal to 40 gsm, greater than or equal to 45 gsm, greater than or equal to 50 gsm, or greater than or equal to 55 gsm. In some embodiments, a prefilter has a basis weight of less than or equal to 60 gsm, less than or equal to 55 gsm, less than or equal to 50 gsm, less than or equal to 45 gsm, less than or equal to 40 gsm, less than or equal to 35 gsm, less than or equal to 30 gsm, less than or equal to 25 gsm, less than or equal to 22.5 gsm, less than or equal to 20 gsm, less than or equal to 17.5 gsm, less than or equal to 15 gsm, less than or equal to 12.5 gsm, less than or equal to 10 gsm, less than or equal to 8 gsm, less than or equal to 7 gsm, less than or equal to 6 gsm, less than or equal to 5 gsm, less than or equal to 4.5 gsm, less than or equal to 4 gsm, less than or equal to 3.5 gsm, less than or equal to 3 gsm, less than or equal to 2.5 gsm, less than or equal to 2 gsm, or less than or equal to 1.5 gsm. Combinations of the above-referenced ranges are also possible (e.g., greater than or equal to 1 gsm and less than or equal to 60 gsm, greater than or equal to 3 gsm and less than or equal to 45 gsm, or greater than or equal to 5 gsm and less than or equal to 25 gsm). The basis weight of a prefilter can be determined in accordance with ISO 536:2012.

In embodiments in which a filter media comprises two or more prefilters, each prefilter may independently have a basis weight in one or more of the ranges described above.

The thicknesses of the prefilters described herein may generally be selected as desired. In some embodiments, a prefilter has a thickness of greater than or equal to 0.01 mm, greater than or equal to 0.015 mm, greater than or equal to 0.02 mm, greater than or equal to 0.025 mm, greater than or equal to 0.03 mm, greater than or equal to 0.035 mm, greater than or equal to 0.04 mm, greater than or equal to 0.045 mm, greater than or equal to 0.05 mm, greater than or equal to 0.06 mm, greater than or equal to 0.07 mm, greater than or equal to 0.08 mm, greater than or equal to 0.09 mm, greater than or equal to 0.1 mm, greater than or equal to 0.15 mm, greater than or equal to 0.2 mm, greater than or equal to 0.25 mm, greater than or equal to 0.3 mm, greater than or equal to 0.35 mm, greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.1 mm, greater than or equal to 1.2 mm, greater than or equal to 1.3 mm, greater than or equal to 1.4 mm, greater than or equal to 1.5 mm, greater than or equal to 1.75 mm, greater than or equal to 2 mm, or greater than or equal to 2.25 mm. In some embodiments, a prefilter has a thickness of less than or equal to 2.5 mm, less than or equal to 2.25 mm, less than or equal to 2 mm, less than or equal to 1.75 mm, less than or equal to 1.5 mm, less than or equal to 1.4 mm, less than or equal to 1.3 mm, less than or equal to 1.2 mm, less than or equal to 1.1 mm, less than or equal to 1 mm, less than or equal to 0.9 mm, less than or equal to 0.8 mm, less than or equal to 0.7 mm, less than or equal to 0.6 mm, less than or equal to 0.5 mm, less than or equal to 0.4 mm, less than or equal to 0.35 mm, less than or equal to 0.3 mm, less than or equal to 0.25 mm, less than or equal to 0.2 mm, less than or equal to 0.15 mm, less than or equal to 0.1 mm, less than or equal to 0.09 mm, less than or equal to 0.08 mm, less than or equal to 0.07 mm, less than or equal to 0.06 mm, less than or equal to 0.05 mm, less than or equal to 0.045 mm, less than or equal to 0.04 mm, less than or equal to 0.035 mm, less than or equal to 0.03 mm, less than or equal to 0.025 mm, less than or equal to 0.02 mm, or less than or equal to 0.015 mm. Combinations of the above-referenced ranges are also possible (e.g., greater than or equal to 0.01 mm and less than or equal to 2.5 mm, greater than or equal to 0.03 mm and less than or equal to 1.3 mm, or greater than or equal to 0.05 mm and less than or equal to 0.5 mm). Other ranges are also possible. The thickness of a prefilter may be determined in accordance with ASTM D1777-96 (2015) under an applied pressure of 0.8 kPa.

In embodiments in which a filter media comprises two or more prefilters, each prefilter may independently have a thickness in one or more of the ranges described above.

Prefilters having a variety of air permeabilities are contemplated. In some embodiments, a prefilter has an air permeability of greater than or equal to 20 CFM, greater than or equal to 25 CFM, greater than or equal to 30 CFM, greater than or equal to 35 CFM, greater than or equal to 40 CFM, greater than or equal to 45 CFM, greater than or equal to 50 CFM, greater than or equal to 60 CFM, greater than or equal to 70 CFM, greater than or equal to 80 CFM, greater than or equal to 90 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, greater than or equal to 350 CFM, greater than or equal to 400 CFM, greater than or equal to 450 CFM, greater than or equal to 500 CFM, greater than or equal to 600 CFM, greater than or equal to 700 CFM, greater than or equal to 800 CFM, or greater than or equal to 900 CFM. In some embodiments, a prefilter has an air permeability of less than or equal to 1000 CFM, less than or equal to 900 CFM, less than or equal to 800 CFM, less than or equal to 700 CFM, less than or equal to 600 CFM, less than or equal to 500 CFM, less than or equal to 450 CFM, less than or equal to 400 CFM, less than or equal to 350 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 90 CFM, less than or equal to 80 CFM, less than or equal to 70 CFM, less than or equal to 60 CFM, less than or equal to 50 CFM, less than or equal to 45 CFM, less than or equal to 40 CFM, less than or equal to 35 CFM, less than or equal to 30 CFM, or less than or equal to 25 CFM. Combinations of the above-referenced ranges are also possible (e.g., greater than or equal to 20 CFM and less than or equal to 1000 CFM, greater than or equal to 40 CFM and less than or equal to 500 CFM, or greater than or equal to 80 CFM and less than or equal to 250 CFM). Other ranges are also possible. The air permeability of a prefilter may be determined in accordance with ASTM D737-04 (2016) at a pressure of 125 Pa.

In embodiments in which a filter media comprises two or more prefilters, each prefilter may independently have an air permeability in one or more of the ranges described above.

The prefilters described herein may be charged or may be uncharged. When present, charge (e.g., electrostatic charge) may be induced on the prefilter by a variety of suitable charging process, non-limiting examples of which include corona discharging (e.g., employing AC corona, employing DC corona), employing an ionic charge bar (e.g., powered by a positive current, powered by a negative current), tribocharging (e.g., hydrocharging, charging by fiber friction), and/or electrospinning (e.g., a filter media may comprise a charged electrospun prefilter that acquired its charge during electro spinning).

A hydro charging process may comprise impinging jets and/or streams of water droplets onto an initially uncharged prefilter to cause it to become charged electrostatically. At the conclusion of the hydro charging process, the prefilter may have an electret charge. The jets and/or streams of water droplets may impinge on the prefilter at a variety of suitable pressures, such as a pressure of between 10 to 50 psi, and may be provided by a variety of suitable sources, such as a sprayer. In some embodiments, a prefilter is hydro charged by using an apparatus that may be employed for the hydroentanglement of fibers which is operated at a lower pressure than is typical for the hydroentangling process. The water impinging on the prefilter may be relatively pure; for instance, it may be distilled water and/or deionized water. After electrostatic charging in this manner, the prefilter may be dried, such as with air dryer.

In some embodiments, a prefilter is hydro charged while being moved laterally. The prefilter may be transported on a porous belt, such as a screen or mesh-type conveyor belt. As it is being transported on the porous belt, it may be exposed to a spray and/or jets of water pressurized by a pump. The water jets and/or spray may impinge on the prefilter and/or penetrate therein. In some embodiments, a vacuum is provided beneath the porous transport belt, which may aid the passage of water through the prefilter and/or reduce the amount of time and energy necessary for drying the prefilter at the conclusion of the hydro charging process.

A fiber friction charging process may comprise bringing into contact and then separating two surfaces, at least one of which is a surface at which fibers to be charged are positioned. This process may cause the transfer of charge between the two surfaces and the associated buildup of charge on the two surfaces. The surfaces may be selected such that they have sufficiently different positions in the triboelectric series to result in a desirable level of charge transfer therebetween upon contact.

In embodiments in which a filter media comprises two or more prefilters, each prefilter may independently be charged or uncharged. Each charged prefilter may independently be charged by one or more of the methods described above. In some embodiments, two or more charging processes may be employed to charge a prefilter. As one particular example, one or more ionic charge bars (e.g., four ionic charge bars) and one or more corona discharging stations may be employed together.

As described above, some filter media described herein comprise an efficiency layer. The efficiency layer may contribute appreciably to the filtration performance of the filter media. In some embodiments, the efficiency layer comprises a non-woven fiber web. The non-woven fiber web may be an electrospun non-woven fiber web, a centrifugal spun non-woven fiber web, and/or a meltblown non-woven fiber web. In some embodiments, the non-woven fiber web comprises continuous fibers (e.g., electrospun fibers, centrifugal spun fibers, meltblown fibers, meltspun fibers).

In embodiments in which a filter media comprises two or more efficiency layers, each efficiency layer may independently comprise one of the non-woven fiber webs described above and/or one or more of the types of fibers described above.

In some embodiments, an efficiency layer comprises synthetic fibers and/or is made up of synthetic fibers (e.g., it may comprise and/or be a synthetic fiber web). For instance, 100 wt % of the fibers in the efficiency layer may be synthetic fibers and/or synthetic material may make up 100 wt % of the efficiency layer. In some embodiments, the synthetic fibers are and/or comprise monocomponent fibers. Non-limiting examples of suitable synthetic fibers include fibers comprising one or more of the following materials: poly(amide)s (e.g., nylons, such as nylon 6), poly(ester)s (e.g., poly(caprolactone), poly(butylene terephthalate)), poly(urethane)s, poly(urea)s, acrylics, polymers comprising a side chain comprising a carbonyl functional group (e.g., poly(vinyl acetate), cellulose ester, poly(acrylamide)), poly(ether sulfone), poly(acrylic)s (e.g., poly(acrylonitrile), poly(acrylic acid)), fluorinated polymers (e.g., poly(vinylidene difluoride)), polyols (e.g., poly(vinyl alcohol)), poly(ether)s (e.g., poly(ethylene oxide)), poly(vinyl pyrrolidone), poly(allylamine), butyl rubber, poly(ethylene), polymers comprising a silane functional group, polymers comprising a thiol functional group, polymers comprising a methylol functional group (e.g., phenolic polymers, melamine polymers, melamine-formaldehyde polymers, crosslinkable polymers comprising pendant methylol groups). In some embodiments, the synthetic fibers are organic polymer fibers.

The efficiency layers described herein may include more than one type of fiber (e.g., two or more different types of monocomponent synthetic fibers, such as poly(amide) fibers and poly(ester) fibers) or may include exclusively one type of fiber (e.g., exclusively monocomponent synthetic fibers comprising a single type of poly(amide)). In some embodiments, the fibers in the efficiency layer comprise fibers comprising a blend of two or more of the polymers listed above (e.g., a blend of two types of poly(amide)s).

Fibers in an efficiency layer (e.g., synthetic fibers) may further comprise one or more additives. By way of example, the fibers in an efficiency layer may comprise a charge-stabilizing additive (e.g., as described above with respect to prefilters) and/or an antimicrobial additive.

In embodiments in which a filter media comprises two or more efficiency layers, each efficiency layer may independently comprise fibers comprising one or more of the materials described above and/or having one or more of the compositions described above.

The efficiency layers described herein may comprise fibers having a variety of suitable average diameters. In some embodiments, an efficiency layer comprises fibers having an average fiber diameter of greater than or equal to 0.01 micron, greater than or equal to 0.02 microns, greater than or equal to 0.03 microns, greater than or equal to 0.04 microns, greater than or equal to 0.05 microns, greater than or equal to 0.06 microns, greater than or equal to 0.08 microns, greater than or equal to 0.1 micron, greater than or equal to 0.2 microns, greater than or equal to 0.3 microns, greater than or equal to 0.5 microns, greater than or equal to 0.6 microns, greater than or equal to 0.8 microns, greater than or equal to 1 micron, or greater than or equal to 1.3 microns. In some embodiments, an efficiency layer comprises fibers having an average fiber diameter of less than or equal to 1.5 microns, less than or equal to 1.3 microns, less than or equal to 1 micron, less than or equal to 0.8 microns, less than or equal to 0.6 microns, less than or equal to 0.5 microns, less than or equal to 0.3 microns, less than or equal to 0.2 microns, less than or equal to 0.1 micron, less than or equal to 0.08 microns, less than or equal to 0.06 microns, less than or equal to 0.05 microns, less than or equal to 0.04 microns, less than or equal to 0.03 microns, or less than or equal to 0.02 microns. Combinations of the above-referenced ranges are also possible (e.g., greater than or equal to 0.01 micron and less than or equal to 1.5 microns, greater than or equal to 0.01 micron and less than or equal to 1 micron, greater than or equal to 0.05 microns and less than or equal to 1 micron, or greater than or equal to 0.1 micron and less than or equal to 0.5 microns). Other ranges are also possible.

In embodiments in which an efficiency layer comprises two or more types of fibers, each type of fiber may independently have an average fiber diameter in one or more of the ranges described above and/or all of the fibers in the efficiency layer may together have an average fiber diameter in one or more of the ranges described above. Similarly, when a filter media comprises two or more efficiency layers, each efficiency layer may independently comprise one or more types of fibers having an average fiber diameter in one or more of the ranges described above and/or may have an average fiber diameter for all of the fibers therein in one or more of the ranges described above.

Some efficiency layers may have relatively low air resistances. In some embodiments, an efficiency layer has an air resistance of less than or equal to 20 mm H₂O, less than or equal to 17.5 mm H₂O, less than or equal to 15 mm H₂O, less than or equal to 12.5 mm H₂O, less than or equal to 10 mm H₂O, less than or equal to 7.5 mm H₂O, less than or equal to 5 mm H₂O, less than or equal to 2 mm H₂O, less than or equal to 1 mm H₂O, less than or equal to 0.75 mm H₂O, less than or equal to 0.5 mm H₂O, less than or equal to 0.4 mm H₂O, less than or equal to 0.3 mm H₂O, less than or equal to 0.2 mm H₂O, or less than or equal to 0.15 mm H₂O. In some embodiments, an efficiency layer has an air resistance of greater than or equal to 0.1 mm H₂O, greater than or equal to 0.15 mm H₂O, greater than or equal to 0.2 mm H₂O, greater than or equal to 0.3 mm H₂O, greater than or equal to 0.4 mm H₂O, greater than or equal to 0.5 mm H₂O, greater than or equal to 0.75 mm H₂O, greater than or equal to 1 mm H₂O, greater than or equal to 2 mm H₂O, greater than or equal to 5 mm H₂O, greater than or equal to 7.5 mm H₂O, greater than or equal to 10 mm H₂O, greater than or equal to 12.5 mm H₂O, greater than or equal to 15 mm H₂O, or greater than or equal to 17.5 mm H₂O. Combinations of the above-referenced ranges are also possible (e.g., less than or equal to 20 mm H₂O and greater than or equal to 0.1 mm H₂O, less than or equal to 15 mm H₂O and greater than or equal to 0.2 mm H₂O, or less than or equal to 10 mm H₂O and greater than or equal to 0.5 mm H₂O). Other ranges are also possible. The air resistance for an efficiency layer may be determined by measuring the air resistance for the filter media as a whole concurrently with the measurement of DOP penetration at 0.33 microns as described elsewhere herein, measuring the air resistance of an otherwise equivalent filter media lacking the efficiency layer concurrently with the measurement of DOP penetration at 0.33 microns as described elsewhere herein, and then subtracting the latter value from the former value.

In embodiments in which a filter media comprises two or more efficiency layers, each efficiency layer may independently have an air resistance in one or more of the ranges described above.

The efficiency layers described herein may have a variety of suitable basis weights. In some embodiments, an efficiency layer has a basis weight of greater than or equal to 0.01 gsm, greater than or equal to 0.015 gsm, greater than or equal to 0.02 gsm, greater than or equal to 0.025 gsm, greater than or equal to 0.05 gsm, greater than or equal to 0.075 gsm, greater than or equal to 0.1 gsm, greater than or equal to 0.2 gsm, greater than or equal to 0.3 gsm, greater than or equal to 0.4 gsm, greater than or equal to 0.5 gsm, greater than or equal to 0.6 gsm, greater than or equal to 0.8 gsm, greater than or equal to 1 gsm, greater than or equal to 1.25 gsm, greater than or equal to 1.5 gsm, greater than or equal to 1.75 gsm, greater than or equal to 2 gsm, greater than or equal to 2.5 gsm, greater than or equal to 3 gsm, greater than or equal to 3.5 gsm, greater than or equal to 4 gsm, or greater than or equal to 4.5 gsm. In some embodiments, an efficiency layer has a basis weight of less than or equal to 5 gsm, less than or equal to 4.5 gsm, less than or equal to 4 gsm, less than or equal to 3.5 gsm, less than or equal to 3 gsm, less than or equal to 2.5 gsm, less than or equal to 2 gsm, less than or equal to 1.75 gsm, less than or equal to 1.5 gsm, less than or equal to 1.25 gsm, less than or equal to 1 gsm, less than or equal to 0.8 gsm, less than or equal to 0.6 gsm, less than or equal to 0.5 gsm, less than or equal to 0.4 gsm, less than or equal to 0.3 gsm, less than or equal to 0.2 gsm, less than or equal to 0.1 gsm, less than or equal to 0.075 gsm, less than or equal to 0.05 gsm, less than or equal to 0.025 gsm, less than or equal to 0.02 gsm, or less than or equal to 0.015 gsm. Combinations of the above-referenced ranges are also possible (e.g., greater than or equal to 0.01 gsm and less than or equal to 5 gsm, greater than or equal to 0.02 gsm and less than or equal to 2 gsm, or greater than or equal to 0.2 gsm and less than or equal to 1.5 gsm). Other ranges are also possible.

In embodiments in which a filter media comprises two or more efficiency layers, each efficiency layer may independently have a basis weight in one or more of the ranges described above.

The thickness of the efficiency layers described herein may be selected as desired. In some embodiments, an efficiency layer has a thickness of greater than or equal to 0.01 micron, greater than or equal to 0.02 microns, greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, or greater than or equal to 17.5 microns. In some embodiments, an efficiency layer has a thickness of less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 20 microns, greater than or equal to 0.05 microns and less than or equal to 15 microns, or greater than or equal to 0.1 micron and less than or equal to 10 microns). Other ranges are also possible. The thickness of an efficiency layer may be determined by performing cross-sectional SEM imaging.

In embodiments in which a filter media comprises two or more efficiency layers, each efficiency layer may independently have a thickness in one or more of the ranges described above.

In some embodiments, a filter media comprises one or more cover layers. A variety of different types of cover layers may be suitable for inclusion in the filter media described herein. Three exemplary such types of cover layers are described in further detail below.

One exemplary type of cover layer is a layer that is disposed on (e.g., directly disposed on) and/or positioned upstream of another layer to protect it. For instance, in some embodiments, a layer that is fairly delicate, such as an electrospun layer and/or an efficiency layer, is covered by a cover layer. The cover layer may mechanically protect the layer on which it is disposed by supporting the layer on which it is disposed and/or serving as a barrier to interaction with an environment external to the layer on which it is disposed. In some embodiments, a cover layer protects the layer on which it is disposed by capturing a portion of the species to be filtered by the layer on which it is disposed.

Another exemplary type of cover layer is a tie-down layer. A tie-down layer may be a layer that is positioned adjacent to (e.g., disposed on, directly disposed on) a layer comprising a type of fiber that would otherwise penetrate outwards an undesirable distance from the surface thereof. The tie-down layer may serve to hold down fibers of this type and/or hold fibers of this type in the interior of the filter media. Tie-down layers may be particularly suitable for use with meltblown layers and/or prefilters (e.g., with meltblown prefilters). In some embodiments, a tie-down layer may be particularly advantageous when positioned in a filter media that is pleated, as it is believed that some types of fibers that tie-down layers may be capable of holding down (e.g., meltblown fibers) may otherwise undesirably crowd the spaces between the pleats.

A third example of an exemplary type of cover layer is a layer positioned on an external surface of the filter media. In some embodiments, a cover layer of this type is positioned on each or both of the outer surfaces of the filter media to protect the filter media as a whole and/or to enhance the visual appearance of the filter media as a whole. For instance, in some such embodiments, the cover layer(s) may be abrasion-resistant and/or aesthetically pleasing.

It should be understood that some cover layers may have one or more of the above-described functionalities, some cover layers may have all of the above-described functionalities, and some cover layers may have functionalities other than those described above. Similarly, it should be understood that filter media may comprise two or more identical cover layers and/or may comprise two or more cover layers differing from each other in one or more ways. In some embodiments, a cover layer has one or both of the above-described functionalities and also contributes to the performance of the filter media, such as by serving as a prefilter.

In some embodiments, a cover layer comprises a non-woven fiber web. A variety of types of non-woven fiber webs may be suitable for use as cover layers. For instance, non-limiting types of layers that may be employed as cover layers include meltblown layers, wetlaid layers, airlaid layers, carded layers, spunbond layers, spunlaid layers, and extruded layers (e.g., meshes, nets). Cover layers may have a variety of suitable physical properties, but typically have relatively low basis weights, relatively low thicknesses, and/or relatively low air resistances.

In embodiments in which a filter media comprises two or more cover layers, each cover layer may independently comprise one or more of the types of layers described above.

In some embodiments, a filter media comprises an adhesive. The adhesive may adhere together two or more components of a filter media (e.g., two or more fiber webs, two or more layers, a prefilter and an efficiency layer, an efficiency layer and a backer, a prefilter and a backer). Suitable adhesives are described in further detail below.

In some embodiments, a filter media comprises an adhesive that is a solvent-based adhesive resin. As used herein, a solvent-based adhesive resin is an adhesive that is capable of undergoing a liquid to solid transition upon the evaporation of a solvent from the resin. Solvent-based adhesive resins may be applied while in the liquid state. Subsequently, the solvent that is present may evaporate to yield a solid adhesive. Solvent-based adhesives may thus be considered to be distinct from hot melt adhesives, which do not comprise volatile solvents (e.g., solvents that evaporate under normal operating conditions) and which typically undergo a liquid to solid transition as the adhesive cools.

In embodiments in which adhesive is present at more than one location, each location at which adhesive is present may independently comprise an adhesive that is a solvent-based adhesive resin.

Desirable properties for adhesives may include sufficient tackiness and open time (i.e., the amount of time that the adhesive remains tacky after being exposed to the ambient atmosphere). Without wishing to be bound by theory, the tackiness of an adhesive may depend on both the glass transition temperature of the adhesive and the molecular weight of any polymeric components of the adhesive. Higher values of glass transition and lower values of molecular weight may promote enhanced tackiness, and higher values of molecular weight may result in higher cohesion in the adhesive and higher bond strength. In some embodiments, adhesives having a glass transition temperature and/or molecular weight in one or more ranges described herein may provide appropriate values of both tackiness and open time. For example, the adhesive may be configured to remain tacky for a relatively long time (e.g., the adhesive may remain tacky after full evaporation of any solvents initially present, and/or may be tacky indefinitely when held at room temperature). In some embodiments, the open time of the adhesive may be less than or equal to 24 hours, less than or equal to 12 hours, less than or equal to 6 hours, less than or equal to 1 hour, less than or equal to 30 minutes, less than or equal to 15 minutes, less than or equal to 10 minutes, less than or equal to 5 minutes, less than or equal to 3 minutes, less than or equal to 1 minute, less than or equal to 30 seconds, or less than or equal to 10 seconds. In some embodiments, the open time of the adhesive may be greater than or equal to 1 second, greater than or equal to 10 seconds, greater than or equal to 15 seconds, greater than or equal to 30 seconds, greater than or equal to 1 minute, greater than or equal to 3 minutes, greater than or equal to 5 minutes, greater than or equal to 10 minutes, greater than or equal to 15 minutes, greater than or equal to 30 minutes, greater than or equal to 1 hour, greater than or equal to 6 hours, or greater than or equal to 12 hours. Combinations of the above-referenced ranges are also possible (e.g., greater than or equal to 1 second and less than or equal to 24 hours). Other values are also possible.

In embodiments in which adhesive is present at more than one location, each location at which adhesive is present may independently comprise an adhesive having an open time in one or more of the ranges described above.

Non-limiting examples of suitable adhesives include adhesives comprising acrylates, acrylate copolymers, poly(urethane)s, poly(ester)s, poly(vinyl alcohol), ethylene-vinyl acetate copolymers, silicone solvents, poly(olefin)s, synthetic and/or natural rubber, synthetic elastomers, ethylene-acrylic acid copolymers, ethylene-methacrylate copolymers, ethylene-methyl methacrylate copolymers, poly(vinylidene chloride), poly(amide)s, epoxies, melamine resins, poly(isobutylene), styrenic block copolymers, styrene-butadiene rubber, aliphatic urethane acrylates, and/or phenolics.

In embodiments in which adhesive is present at more than one location, each location at which adhesive is present may independently comprise an adhesive comprising one or more of the materials described above.

When present, an adhesive may comprise a crosslinker and/or may be crosslinked. In some embodiments, the crosslinker is a small molecule (i.e., it is non-polymeric) and/or the crosslink is a reaction product of a small molecule crosslinker. In some embodiments, an adhesive comprises a small molecule crosslinker (and/or a reaction product thereof) that is one or more of a carbodiimide, an isocyanate, an aziridine, a zirconium compound such as zirconium carbonate, a metal acid ester, a metal chelate, a multifunctional propylene imine, and an amino resin. In some embodiments, the adhesive comprises at least one polymer and/or prepolymer with one or more reactive functional groups that are capable of reacting with the crosslinker and/or comprises a reaction product of one or more reactive functional groups on a polymer and/or prepolymer that have reacted with the crosslinker. Non-limiting examples of suitable reactive functional groups include alcohol groups, carboxylic acid groups, epoxy groups, amine groups, and amino groups. In some embodiments, a filter media comprises an adhesive that comprises one or more polymers and/or prepolymers that may undergo self-crosslinking via functional groups attached thereto. Some filter media may comprise an adhesive that comprises a self-crosslinked reaction product of one or more polymers and/or prepolymers.

In embodiments in which adhesive is present at more than one location, each location at which adhesive is present may independently comprise an adhesive comprising one or more of the materials described above.

When present, a small molecule crosslinker and/or crosslinks that are reaction products thereof may make up any suitable amount of an adhesive. In some embodiments, the wt % of the small molecule crosslinker and/or crosslinks that are reaction products thereof is greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 15 wt %, greater than or equal to 20 wt %, or greater than or equal to 25 wt % with respect to the total mass of the adhesive. In some embodiments, the wt % of the small molecule crosslinker and/or crosslinks that are reaction products thereof is less than or equal to 30 wt %, less than or equal to 25 wt %, less than or equal to 20 wt %, less than or equal to 15 wt %, less than or equal to 10 wt %, less than or equal to 5 wt %, less than or equal to 2 wt %, less than or equal to 1 wt %, less than or equal to 0.5 wt %, or less than or equal to 0.2 wt % with respect to the total mass of the adhesive. Combinations of the above-referenced ranges are also possible (e.g., greater than or equal to 0.1 wt % and less than or equal to 30 wt %, or greater than or equal to 1 wt % and less than or equal to 20 wt %). Other ranges are also possible.

In embodiments in which adhesive is present at more than one location, each location at which adhesive is present may independently comprise an adhesive comprising a small molecule crosslinker and/or crosslinks that are reaction products thereof in one or more of the amounts described above.

The adhesive and/or any small molecule crosslinkers therein may be capable of undergoing a crosslinking reaction at any suitable temperature and/or may have undergone a crosslinking reaction at any suitable temperature. In some embodiments, an adhesive may be capable of undergoing a crosslinking reaction and/or may have undergone a crosslinking reaction at a temperature of greater than or equal to 24° C., greater than or equal to 40° C., greater than or equal to 50° C., greater than or equal to 60° C., greater than or equal to 70° C., greater than or equal to 80° C., greater than or equal to 90° C., greater than or equal to 100° C., greater than or equal to 110° C., greater than or equal to 120° C., greater than or equal to 130° C., or greater than or equal to 140° C. In some embodiments, an adhesive may be capable of undergoing a crosslinking reaction and/or may have undergone a crosslinking reaction at a temperature of less than or equal to 150° C., less than or equal to 140° C., less than or equal to 130° C., less than or equal to 120° C., less than or equal to 110° C., less than or equal to 100° C., less than or equal to 90° C., less than or equal to 80° C., less than or equal to 70° C., less than or equal to 60° C., less than or equal to 50° C., or less than or equal to 40° C. Combinations of the above-referenced ranges are also possible (e.g., greater than or equal to 25° C. and less than or equal to 150° C., or greater than or equal to 25° C. and less than or equal to 130° C.). Other ranges are also possible.

In embodiments in which adhesive is present at more than one location, each location at which adhesive is present may independently comprise an adhesive capable of undergoing a crosslinking reaction and/or that has undergone a crosslinking reaction at a temperature in one or more of the ranges described above.

When present, an adhesive may comprise a solvent and/or may be formed from a composition comprising a solvent (e.g., from which the solvent has evaporated). By way of example, some embodiments relate to an adhesive applied to a component of the filter media (e.g., a fiber web) and/or filter media while dissolved and/or suspended in a solvent. Non-limiting examples of suitable solvents include water, hydrocarbon solvents, ketones, aromatic solvents, fluorinated solvents, toluene, heptane, acetone, n-butyl acetate, methyl ethyl ketone, methylene chloride, naphtha, and mineral spirits.

In embodiments in which adhesive is present at more than one location, each location at which adhesive is present may independently comprise one or more of the solvents described above and/or may be formed from a composition comprising one or more of the solvents described above.

When present, an adhesive may have a relatively low glass transition temperature. In some embodiments, an adhesive has a glass transition temperature of less than or equal to 60° C., less than or equal to 50° C., less than or equal to 45° C., less than or equal to 40° C., less than or equal to 35° C., less than or equal to 30° C., less than or equal to 25° C., less than or equal to 24° C., less than or equal to 20° C., less than or equal to 15° C., less than or equal to 10° C., less than or equal to 5° C., less than or equal to 0° C., less than or equal to −5° C., less than or equal to −10° C., less than or equal to −20° C., less than or equal to −30° C., less than or equal to −40° C., less than or equal to −50° C., less than or equal to −60° C., less than or equal to −70° C., less than or equal to −80° C., less than or equal to −90° C., less than or equal to −100° C., or less than or equal to −110° C. In some embodiments, an adhesive has a glass transition temperature of greater than or equal to −125° C., greater than or equal to −110° C., greater than or equal to −100° C., greater than or equal to −90° C., greater than or equal to −80° C., greater than or equal to −70° C., greater than or equal to −60° C., greater than or equal to −50° C., greater than or equal to −40° C., greater than or equal to −30° C., greater than or equal to −20° C., greater than or equal to −10° C., greater than or equal to 0° C., greater than or equal to 5° C., greater than or equal to 10° C., greater than or equal to 24° C., greater than or equal to 25° C., greater than or equal to 40° C., or greater than or equal to 50° C. Combinations of the above-referenced ranges are also possible (e.g., greater than or equal to −125° C. and less than or equal to 60° C., or greater than or equal to −100° C. and less than or equal to 25° C.). Other ranges are also possible. The value of the glass transition temperature for an adhesive may be measured by differential scanning calorimetry as described above.

In embodiments in which adhesive is present at more than one location, each location at which adhesive is present may independently comprise an adhesive having a glass transition temperature in one or more of the ranges described above.

When present, an adhesive and/or a component therein (e.g., a polymeric component) may have a variety of suitable molecular weights. In some embodiments, an adhesive and/or a component therein has a number average molecular weight of greater than or equal to 10 kDa, greater than or equal to 30 kDa, greater than or equal to 50 kDa, greater than or equal to 100 kDa, greater than or equal to 300 kDa, greater than or equal to 500 kDa, greater than or equal to 1000 kDa, greater than or equal to 2000 kDa, or greater than or equal to 3000 kDa. In some embodiments, an adhesive and/or a component therein has a number average molecular weight of less than or equal to 5000 kDa, less than or equal to 4000 kDa, less than or equal to 3000 kDa, less than or equal to 1000 kDa, less than or equal to 500 kDa, less than or equal to 300 kDa, less than or equal to 100 kDa, less than or equal to 50 kDa, or less than or equal to 30 kDa. Combinations of the above-referenced ranges are also possible (e.g., greater than or equal to 10 kDa and less than or equal to 5000 kDa, or greater than or equal to 30 kDa and less than or equal to 3000 kDa). Other ranges are also possible. The number average molecular weight may be measured by light scattering.

In embodiments in which an adhesive comprises more than one component, each component therein may independently have a molecular weight in one or more of the above-referenced ranges. In embodiments in which adhesive is present at more than one location, each location at which adhesive is present may independently comprise an adhesive having a molecular weight in one or more of the ranges described above and/or may independently comprise an adhesive comprising one or more components having a molecular weight in one or more of the ranges described above.

When present, an adhesive may have a variety of suitable basis weights. In some embodiments, an adhesive has a basis weight of greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, an adhesive has a basis weight of less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible.

In embodiments in which adhesive is present at more than one location, each location at which adhesive is present may independently comprise an adhesive having a basis weight in one or more of the ranges described above.

In embodiments where the filter media comprises one or more adhesives, the total basis weight of the adhesives in the filter media together (i.e., the sum of the basis weights of the adhesive at each location) may be greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, the total basis weight of the adhesives in the filter media together may be less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible.

When present, an adhesive may adhere together two or more components of the filter media (e.g., two or more fiber webs, two or more layers, a prefilter and an efficiency layer, an efficiency layer and a backer, a prefilter and a backer) between which it is positioned. The strength of adhesion between the two components of the filter media may be relatively high. For instance, an adhesive may adhere two components of the filter media together with a bond strength of greater than or equal to 100 g/in², greater than or equal to 150 g/in², greater than or equal to 200 g/in², greater than or equal to 500 g/in², greater than or equal to 750 g/in², greater than or equal to 1000 g/in², greater than or equal to 1250 g/in², greater than or equal to 1500 g/in², greater than or equal to 1750 g/in², greater than or equal to 2000 g/in², greater than or equal to 2250 g/in², greater than or equal to 2500 g/in², greater than or equal to 2750 g/in², greater than or equal to 3000 g/in², greater than or equal to 3250 g/in², greater than or equal to 3500 g/in², greater than or equal to 3750 g/in², greater than or equal to 4000 g/in², greater than or equal to 4250 g/in², greater than or equal to 4500 g/in², or greater than or equal to 4750 g/in². In some embodiments, an adhesive adheres two components of the filter media together with a bond strength of less than or equal to 5000 g/in², less than or equal to 4750 g/in², less than or equal to 4500 g/in², less than or equal to 4250 g/in², less than or equal to 4000 g/in², less than or equal to 3750 g/in², less than or equal to 3500 g/in², less than or equal to 3250 g/in², less than or equal to 3000 g/in², less than or equal to 2750 g/in², less than or equal to 2500 g/in², less than or equal to 2250 g/in², less than or equal to 2000 g/in², less than or equal to 1750 g/in², less than or equal to 1500 g/in², less than or equal to 1250 g/in², less than or equal to 1000 g/in², less than or equal to 750 g/in², less than or equal to 500 g/in², less than or equal to 200 g/in², or less than or equal to 150 g/in². Combinations of the above-referenced ranges are also possible (e.g., greater than or equal to 100 g/in² and less than or equal to 5000 g/in², or greater than or equal to 150 g/in² and less than or equal to 3000 g/in²). Other ranges are also possible.

In embodiments in which adhesive is present at more than one location, each location at which adhesive is present may independently comprise an adhesive adhering together two components of the filter media with a bond strength in one or more of the ranges described above. In some embodiments, the entire filter media as a whole has an internal bond strength in one or more ranges described above. The bond strength of the entire filter media as a whole is equivalent to the weakest bond strength between any two components of the filter media.

The bond strength (e.g., internal bond strength) between two components of the filter media (e.g., between two fiber webs adhered together by an adhesive) may be determined by using a z-directional peel strength test. In short, the bond strength may be determined by the following procedure. First, a 1 in×1 in sample may be mounted on a steel block with dimensions 1 in×1 in×0.5 in using double sided tape. The steel block may then be mounted onto the non-traversing head of a tensile tester and another steel block of the same size may be connected to the traversing head with double sided tape. The traversing head may brought down and bonded to the sample on the steel block of the non-traversing head. Enough pressure may be applied so that the steel blocks are bonded together via the mounted sample. The traversing head may then be moved at a traversing speed of 1 in/min, during which the stress is recorded as a function of strain. After this procedure, the maximum load may be found from the peak of a stress-strain curve. The bond strength (e.g., internal bond strength) between the two components of the filter media is considered to be equivalent to the maximum load measured by this procedure.

Some adhesives described herein may be pressure-sensitive adhesives. Such adhesives may be configured to bond together two components of a filter media with a bond strength that increases upon the application of pressure thereto. In embodiments in which adhesive is present at more than one location, each location at which adhesive is present may independently comprise a pressure-sensitive adhesive.

In some embodiments, a filter media described herein has a relatively high value of initial DOP gamma at 0.33 microns and/or at the most penetrating particle size (MPPS). In some embodiments, a filter media described herein has a relatively low initial DOP penetration at 0.33 microns and/or at the MPPS. The DOP gamma at a particular particle size (e.g., 0.33 microns, the MPPS) is defined by the following formula: DOP gamma=(−log₁₀(initial DOP penetration at the particle size, %/100%)/(initial air resistance, mm H₂O))×100. The initial DOP penetration at a particular particle size (e.g., 0.33 microns, the MPPS) and the initial air resistance may be determined concurrently with the initial DOP penetration as described elsewhere herein. As described elsewhere herein, the initial DOP gamma refers to the DOP gamma measured from the beginning of the testing procedure to the time required to make the initial measurements of DOP penetration and air resistance.

The initial DOP penetration at 0.33 microns may be determined for filter media by following the same procedure described elsewhere herein for initial DOP penetration at 0.33 microns for the backer.

The MPPS penetration is the penetration of the most penetrating particle size; in other words, when penetration is measured for a range of particle sizes, the MPPS penetration is the value of penetration measured for the particle with the highest penetration. Initial MPPS penetration and initial air resistance, and accordingly initial DOP gamma at the MPPS, can be measured by employing a TSI 3160 equipped with a dioctyl phthalate generator for DOP aerosol testing and the CertiTest software loaded thereon. Briefly, the procedure encoded by the CertiTest software comprises blowing DOP particles through a filter media and measuring the percentage of particles that penetrate therethrough and the air resistance as the particles are blown through the filter media. The TSI 3160 may be employed to sequentially blow populations of DOP particles with varying average particle diameters at a 100 cm² portion of the upstream face of the filter media. Before blowing the populations of particles at the upstream face of the filter media, the TSI 3160 may be balanced for a period of time between 20 seconds and 180 seconds and such that the deviation is less than or equal to 1%. The populations of particles may then be blown at the upstream face of the filter media in order of increasing average diameter, and may have the following set of average diameters: 0.03 microns, 0.06 microns, 0.08 microns, 0.13 microns, and 0.2 microns. Each population of particles may be blown at an air flow of 12 L/min, a face velocity of 2 cm/s, for a period of time between 20 seconds and 400 seconds, and such that at least 70 downstream counts are obtained.

In some embodiments, a filter media has an initial DOP gamma at 0.33 microns and/or at the MPPS of greater than or equal to 8, greater than or equal to 8.5, greater than or equal to 9, greater than or equal to 9.5, greater than or equal to 10, greater than or equal to 12.5, greater than or equal to 15, greater than or equal to 17.5, greater than or equal to 20, greater than or equal to 25, greater than or equal to 30, greater than or equal to 40, greater than or equal to 50, greater than or equal to 60, greater than or equal to 70, greater than or equal to 80, greater than or equal to 90, greater than or equal to 100, or greater than or equal to 125. In some embodiments, a filter media has an initial DOP gamma at 0.33 microns and/or at the MPPS of less than or equal to 150, less than or equal to 125, less than or equal to 100, less than or equal to 90, less than or equal to 80, less than or equal to 70, less than or equal to 60, less than or equal to 50, less than or equal to 40, less than or equal to 30, less than or equal to 25, less than or equal to 20, less than or equal to 17.5, less than or equal to 15, less than or equal to 12.5, less than or equal to 10, less than or equal to 9.5, less than or equal to 9, or less than or equal to 8.5. Combinations of the above-referenced ranges are also possible (e.g., greater than or equal to 8 and less than or equal to 150, greater than or equal to 9 and less than or equal to 100, or greater than or equal to 10 and less than or equal to 90). Other ranges are also possible.

A filter media may independently have an initial DOP gamma (e.g., at 0.33 microns, at the MPPS) in one or more of the above-referenced ranges prior to exposure to isopropyl alcohol (vapor) and/or after undergoing an IPA vapor discharge process.

IPA vapor discharge may be performed in accordance with the ISO 16890-4 (2016) standard on a 6 in by 6 in sample. A filter media to be tested may be cut into a 6 in by 6 in square and placed on a shelf of a metal rack. Then, the metal rack and the media may be placed over a container comprising at least 250 mL of 99.9 wt % IPA. After this step, the metal rack, media, and container may be placed inside a 24 in by 18 in by 11 in chamber. A second container comprising 250 mL of 99.9 wt % IPA may then be placed in the container over the top shelf of the metal rack, and the lid of the chamber may be closed and tightly sealed. This setup may be maintained at 70° F. and 50% relative humidity for at least 14 hours, after which the filter media may be removed and allowed to dry for one hour at room temperature. Then, the filter media properties characterized as being those after undergoing an IPA vapor discharge process may be measured.

A filter media may have an initial DOP penetration at 0.33 microns and/or at the MPPS of less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 40%, less than or equal to 30%, less than or equal to 20%, less than or equal to 10%, less than or equal to 5%, less than or equal to 2%, less than or equal to 1%, less than or equal to 0.5%, less than or equal to 0.2%, less than or equal to 0.1%, less than or equal to 0.005%, less than or equal to 0.002%, less than or equal to 0.001%, less than or equal to 0.0005%, less than or equal to 0.0002%, less than or equal to 0.0001%, less than or equal to 0.00005%, less than or equal to 0.00002%, less than or equal to 0.00001%, less than or equal to 0.000005%, or less than or equal to 0.000002%. In some embodiments, a filter media has an initial DOP penetration at 0.33 microns and/or at the MPPS of greater than or equal to 0.000001%, greater than or equal to 0.000002%, greater than or equal to 0.000005%, greater than or equal to 0.00001%, greater than or equal to 0.00002%, greater than or equal to 0.00005%, greater than or equal to 0.0001%, greater than or equal to 0.0002%, greater than or equal to 0.0005%, greater than or equal to 0.001%, greater than or equal to 0.002%, greater than or equal to 0.005%, greater than or equal to 0.01%, greater than or equal to 0.02%, greater than or equal to 0.05%, greater than or equal to 0.1%, greater than or equal to 0.2%, greater than or equal to 0.5%, greater than or equal to 1%, greater than or equal to 2%, greater than or equal to 5%, greater than or equal to 10%, greater than or equal to 20%, greater than or equal to 30%, greater than or equal to 40%, greater than or equal to 50%, greater than or equal to 55%, greater than or equal to 60%, greater than or equal to 65%, greater than or equal to 70%, greater than or equal to 75%, greater than or equal to 80%, or greater than or equal to 85%. Combinations of the above-referenced ranges are also possible (e.g., less than or equal to 90% and greater than or equal to 0.000001%, less than or equal to 75% and greater than or equal to 0.00001%, or less than or equal to 60% and greater than or equal to 0.001%). Other ranges are also possible.

A filter media may independently have an initial DOP penetration in one or more of the above-referenced ranges (e.g., at 0.33 microns, at the MPPS) prior to exposure to IPA vapor and/or after undergoing an IPA vapor discharge process.

In some embodiments, a filter media has an initial air resistance of less than or equal to 20 mm H₂O, less than or equal to 17.5 mm H₂O, less than or equal to 15 mm H₂O, less than or equal to 12.5 mm H₂O, less than or equal to 10 mm H₂O, less than or equal to 7.5 mm H₂O, less than or equal to 5 mm H₂O, less than or equal to 2.5 mm H₂O, less than or equal to 2 mm H₂O, less than or equal to 1.5 mm H₂O, less than or equal to 1 mm H₂O, less than or equal to 0.75 mm H₂O, or less than or equal to 0.5 mm H₂O. In some embodiments, a filter media has an initial air resistance of greater than or equal to 0.25 mm H₂O, greater than or equal to 0.5 mm H₂O, greater than or equal to 0.75 mm H₂O, greater than or equal to 1 mm H₂O, greater than or equal to 1.5 mm H₂O, greater than or equal to 2 mm H₂O, greater than or equal to 2.5 mm H₂O, greater than or equal to 5 mm H₂O, greater than or equal to 7.5 mm H₂O, greater than or equal to 10 mm H₂O, greater than or equal to 12.5 mm H₂O, greater than or equal to 15 mm H₂O, or greater than or equal to 17.5 mm H₂O. Combinations of the above-referenced ranges are also possible (e.g., less than or equal to 20 mm H₂O and greater than or equal to 0.25 mm H₂O, less than or equal to 15 mm H₂O and greater than or equal to 0.5 mm H₂O, or less than or equal to 10 mm H₂O and greater than or equal to 1 mm H₂O). Other ranges are also possible.

It should be understood that a filter media may independently have an initial air resistance in one or more of the above-referenced ranges as measured by the procedure described elsewhere herein for initial penetration of 0.33 micron DOP particles and as measured by the procedure described elsewhere herein for initial penetration of MPPS particles. Similarly, a filter media may independently have an initial air resistance in one or more of the above-referenced ranges (e.g., as measured by the procedure described elsewhere herein for initial penetration of 0.33 micron DOP particles, as measured by the procedure described elsewhere herein for initial penetration of MPPS particles) prior to exposure to IPA vapor and/or after undergoing an IPA vapor discharge process.

The filter media described herein may have relatively high dust holding capacities. In some embodiments, a filter media has a dust holding capacity of greater than or equal to 1 g, greater than or equal to 1.1 g, greater than or equal to 1.2 g, greater than or equal to 1.3 g, greater than or equal to 1.4 g, greater than or equal to 1.5 g, greater than or equal to 1.6 g, greater than or equal to 1.8 g, greater than or equal to 2 g, greater than or equal to 2.25 g, greater than or equal to 2.5 g, greater than or equal to 2.75 g, greater than or equal to 3 g, greater than or equal to 3.5 g, greater than or equal to 4 g, greater than or equal to 4.5 g, greater than or equal to 5 g, greater than or equal to 5.5 g, greater than or equal to 6 g, or greater than or equal to 6.5 g. In some embodiments, a filter media has a dust holding capacity of less than or equal to 7 g, less than or equal to 6.5 g, less than or equal to 6 g, less than or equal to 5.5 g, less than or equal to 5 g, less than or equal to 4.5 g, less than or equal to 4 g, less than or equal to 3.5 g, less than or equal to 3 g, less than or equal to 2.75 g, less than or equal to 2.5 g, less than or equal to 2.25 g, less than or equal to 2 g, less than or equal to 1.8 g, less than or equal to 1.6 g, less than or equal to 1.5 g, less than or equal to 1.4 g, less than or equal to 1.3 g, less than or equal to 1.2 g, or less than or equal to 1.1 g. Combinations of the above-referenced ranges are also possible (e.g., greater than or equal to 1 g and less than or equal to 5 g, greater than or equal to 1.2 g and less than or equal to 4 g, or greater than or equal to 1.5 g and less than or equal to 3.5 g). Other ranges are also possible. Dust holding capacity may be determined in accordance with ASHRAE 52.2 (2017) performed at a flow rate of 15 ft/min, performed until the filter media has an air resistance of 1.5 inches of H₂O, and performed using ASHRAE Test Dust #1.

In some embodiments, a filter media may be relatively resistant to catching on fire. For instance, the filter media may have an “F” classification of F1, F2, or F3 as determined by performing the procedure described in DIN 534381-3 (1984). As another example, the filter media may have a “K” classification of K1, K2, or K3 as determined by performing the procedure described in DIN 534381-2 (1984).

The filter media described herein may have a variety of suitable basis weights. In some embodiments, a filter media has a basis weight of greater than or equal to 20 gsm, greater than or equal to 25 gsm, greater than or equal to 30 gsm, greater than or equal to 35 gsm, greater than or equal to 40 gsm, greater than or equal to 45 gsm, greater than or equal to 50 gsm, greater than or equal to 55 gsm, greater than or equal to 60 gsm, greater than or equal to 70 gsm, greater than or equal to 80 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, or greater than or equal to 275 gsm. In some embodiments, a filter media has a basis weight of less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 80 gsm, less than or equal to 70 gsm, less than or equal to 60 gsm, less than or equal to 55 gsm, less than or equal to 50 gsm, less than or equal to 45 gsm, less than or equal to 40 gsm, less than or equal to 35 gsm, less than or equal to 30 gsm, or less than or equal to 25 gsm. Combinations of the above-referenced ranges are also possible (e.g., greater than or equal to 20 gsm and less than or equal to 300 gsm, greater than or equal to 35 gsm and less than or equal to 250 gsm, or greater than or equal to 55 gsm and less than or equal to 150 gsm). Other ranges are also possible. The basis weight of a filter media may be determined in accordance with ISO 536:2012.

The thicknesses of the filter media described herein may generally be selected as desired. In some embodiments, a filter media has a thickness of greater than or equal to 0.15 mm, greater than or equal to 0.2 mm, greater than or equal to 0.25 mm, greater than or equal to 0.3 mm, greater than or equal to 0.35 mm, greater than or equal to 0.4 mm, greater than or equal to 0.5 mm, greater than or equal to 0.6 mm, greater than or equal to 0.7 mm, greater than or equal to 0.8 mm, greater than or equal to 1 mm, greater than or equal to 1.25 mm, greater than or equal to 1.5 mm, greater than or equal to 1.75 mm, greater than or equal to 2 mm, greater than or equal to 2.25 mm, greater than or equal to 2.5 mm, greater than or equal to 2.75 mm, greater than or equal to 3 mm, greater than or equal to 3.5 mm, greater than or equal to 4 mm, or greater than or equal to 4.5 mm. In some embodiments, a filter media has a thickness of less than or equal to 5 mm, less than or equal to 4.5 mm, less than or equal to 4 mm, less than or equal to 3.5 mm, less than or equal to 3 mm, less than or equal to 2.75 mm, less than or equal to 2.5 mm, less than or equal to 2.25 mm, less than or equal to 2 mm, less than or equal to 1.75 mm, less than or equal to 1.5 mm, less than or equal to 1.25 mm, less than or equal to 1 mm, less than or equal to 0.8 mm, less than or equal to 0.7 mm, less than or equal to 0.6 mm, less than or equal to 0.5 mm, less than or equal to 0.4 mm, less than or equal to 0.35 mm, less than or equal to 0.3 mm, less than or equal to 0.25 mm, or less than or equal to 0.2 mm. Combinations of the above-referenced ranges are also possible (e.g., greater than or equal to 0.15 mm and less than or equal to 5 mm, greater than or equal to 0.25 mm and less than or equal to 2.5 mm, or greater than or equal to 0.35 mm and less than or equal to 1.25 mm). Other ranges are also possible. The thickness of a filter media may be determined in accordance with ASTM D1777-96 (2015) under an applied pressure of 0.8 kPa.

Filter media having a variety of air permeabilities are contemplated. In some embodiments, a filter media has an air permeability of greater than or equal to 15 CFM, greater than or equal to 20 CFM, greater than or equal to 25 CFM, greater than or equal to 30 CFM, greater than or equal to 35 CFM, greater than or equal to 40 CFM, greater than or equal to 45 CFM, greater than or equal to 50 CFM, greater than or equal to 60 CFM, greater than or equal to 70 CFM, greater than or equal to 80 CFM, greater than or equal to 90 CFM, greater than or equal to 100 CFM, greater than or equal to 125 CFM, greater than or equal to 150 CFM, greater than or equal to 175 CFM, greater than or equal to 200 CFM, greater than or equal to 250 CFM, greater than or equal to 300 CFM, greater than or equal to 350 CFM, greater than or equal to 400 CFM, or greater than or equal to 450 CFM. In some embodiments, a filter media has an air permeability of less than or equal to 500 CFM, less than or equal to 450 CFM, less than or equal to 400 CFM, less than or equal to 350 CFM, less than or equal to 300 CFM, less than or equal to 250 CFM, less than or equal to 200 CFM, less than or equal to 175 CFM, less than or equal to 150 CFM, less than or equal to 125 CFM, less than or equal to 100 CFM, less than or equal to 90 CFM, less than or equal to 80 CFM, less than or equal to 70 CFM, less than or equal to 60 CFM, less than or equal to 50 CFM, less than or equal to 45 CFM, less than or equal to 40 CFM, less than or equal to 35 CFM, less than or equal to 30 CFM, less than or equal to 25 CFM, or less than or equal to 20 CFM. Combinations of the above-referenced ranges are also possible (e.g., greater than or equal to 15 CFM and less than or equal to 500 CFM, greater than or equal to 20 CFM and less than or equal to 300 CFM, or greater than or equal to 25 CFM and less than or equal to 150 CFM). Other ranges are also possible. The air permeability of a filter media may be determined in accordance with ASTM D737-04 (2016) at a pressure of 125 Pa.

The filter media described herein may have a variety of suitable values of mean flow pore size. In some embodiments, a filter media has a mean flow pore size of greater than or equal to 0.5 microns, greater than or equal to 0.75 microns, greater than or equal to 1 micron, greater than or equal to 1.5 microns, greater than or equal to 2 microns, greater than or equal to 3 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, or greater than or equal to 27.5 microns. In some embodiments, a filter media has a mean flow pore size of less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 3 microns, less than or equal to 2 microns, less than or equal to 1.5 microns, less than or equal to 1 micron, or less than or equal to 0.75 microns. Combinations of the above-referenced ranges are also possible (e.g., greater than or equal to 0.5 microns and less than or equal to 30 microns). Other ranges are also possible. The mean flow pore size of a filter media may be determined in accordance with ASTM F316 (2003).

In some embodiments, a filter media described herein has a relatively high stiffness in the machine direction. The filter media may have a stiffness in the machine direction of greater than or equal to 200 mg, greater than or equal to 250 mg, greater than or equal to 300 mg, greater than or equal to 400 mg, greater than or equal to 500 mg, greater than or equal to 600 mg, greater than or equal to 800 mg, greater than or equal to 1000 mg, greater than or equal to 1250 mg, greater than or equal to 1500 mg, or greater than or equal to 1750 mg. The filter media may have a stiffness in the machine direction of less than or equal to 2000 mg, less than or equal to 1750 mg, less than or equal to 1500 mg, less than or equal to 1250 mg, less than or equal to 1000 mg, less than or equal to 800 mg, less than or equal to 600 mg, less than or equal to 500 mg, less than or equal to 400 mg, less than or equal to 300 mg, or less than or equal to 250 mg. Combinations of the above-referenced ranges are also possible (e.g., greater than or equal to 200 mg and less than or equal to 2000 mg). Other ranges are also possible. The stiffness of a filter media in the machine direction may be determined in accordance with TAPPI T543 om-05 (2005) using a sample size of 2 in×2.5 in.

The ratio of the stiffness in the machine direction to the stiffness in the cross direction may generally be selected as desired. In some embodiments, a filter media has a ratio of stiffness in the machine direction to stiffness in the cross direction of greater than or equal to 1, greater than or equal to 1.25, greater than or equal to 1.5, greater than or equal to 1.75, greater than or equal to 2, greater than or equal to 2.5, greater than or equal to 3, greater than or equal to 3.5, greater than or equal to 4, greater than or equal to 5, greater than or equal to 6, greater than or equal to 7, greater than or equal to 8, or greater than or equal to 9. In some embodiments, a filter media has a ratio of stiffness in the machine direction to stiffness in the cross direction of less than or equal to 10, less than or equal to 9, less than or equal to 8, less than or equal to 7, less than or equal to 6, less than or equal to 5, less than or equal to 4, less than or equal to 3.5, less than or equal to 2, less than or equal to 1.75, less than or equal to 1.5, or less than or equal to 1.25. Combinations of the above-referenced ranges are also possible (e.g., greater than or equal to 1 and less than or equal to 10). Other ranges are also possible. The stiffness of a filter media in the cross direction may be determined in accordance with TAPPI T543 om-05 (2005) using a sample size of 2 in×2.5 in.

The filter media described herein may have relatively high values of dry tensile strength in the machine direction. In some embodiments, a filter media has a dry tensile strength in the machine direction of greater than or equal to 10 lbs/in, greater than or equal to 12.5 lbs/in, greater than or equal to 15 lbs/in, greater than or equal to 17.5 lbs/in, greater than or equal to 20 lbs/in, greater than or equal to 25 lbs/in, greater than or equal to 30 lbs/in, greater than or equal to 35 lbs/in, greater than or equal to 40 lbs/in, greater than or equal to 50 lbs/in, greater than or equal to 60 lbs/in, greater than or equal to 70 lbs/in, greater than or equal to 80 lbs/in, or greater than or equal to 90 lbs/in. In some embodiments, a filter media has a dry tensile strength in the machine direction of less than or equal to 100 lbs/in, less than or equal to 90 lbs/in, less than or equal to 80 lbs/in, less than or equal to 70 lbs/in, less than or equal to 60 lbs/in, less than or equal to 50 lbs/in, less than or equal to 40 lbs/in, less than or equal to 35 lbs/in, less than or equal to 30 lbs/in, less than or equal to 25 lbs/in, less than or equal to 20 lbs/in, less than or equal to 17.5 lbs/in, less than or equal to 15 lbs/in, or less than or equal to 12.5 lbs/in. Combinations of the above-referenced ranges are also possible (e.g., greater than or equal to 10 lbs/in and less than or equal to 100 lbs/in). Other ranges are also possible. The dry tensile strength in the machine direction of a filter media may be determined in accordance with T494 om-96 using a test span of 4 in and a jaw separation speed of 1 in/min.

The filter media described herein may have relatively high values of dry tensile strength in the cross direction. In some embodiments, a filter media has a dry tensile strength in the cross direction of greater than or equal to 1 lb/in, greater than or equal to 1.5 lbs/in, greater than or equal to 2 lbs/in, greater than or equal to 3 lbs/in, greater than or equal to 4 lbs/in, greater than or equal to 5 lbs/in, greater than or equal to 7.5 lbs/in, greater than or equal to 10 lbs/in, greater than or equal to 12.5 lbs/in, greater than or equal to 15 lbs/in, greater than or equal to 17.5 lbs/in, greater than or equal to 20 lbs/in, greater than or equal to 25 lbs/in, greater than or equal to 30 lbs/in, greater than or equal to 35 lbs/in, greater than or equal to 40 lbs/in, greater than or equal to 50 lbs/in, greater than or equal to 60 lbs/in, greater than or equal to 70 lbs/in, greater than or equal to 80 lbs/in, or greater than or equal to 90 lbs/in. In some embodiments, a filter media has a dry tensile strength in the cross direction of less than or equal to 100 lbs/in, less than or equal to 90 lbs/in, less than or equal to 80 lbs/in, less than or equal to 70 lbs/in, less than or equal to 60 lbs/in, less than or equal to 50 lbs/in, less than or equal to 40 lbs/in, less than or equal to 35 lbs/in, less than or equal to 30 lbs/in, less than or equal to 25 lbs/in, less than or equal to 20 lbs/in, less than or equal to 17.5 lbs/in, less than or equal to 15 lbs/in, less than or equal to 12.5 lbs/in, less than or equal to 10 lbs/in, less than or equal to 7.5 lbs/in, less than or equal to 5 lbs/in, less than or equal to 4 lbs/in, less than or equal to 3 lbs/in, less than or equal to 2 lbs/in, or less than or equal to 1.5 lbs/in. Combinations of the above-referenced ranges are also possible (e.g., greater than or equal to 1 lb/in and less than or equal to 100 lbs/in). Other ranges are also possible. The dry tensile strength in the cross direction of a filter media may be determined in accordance with T494 om-96 using a test span of 4 in and a jaw separation speed of 1 in/min.

The ratio of the dry tensile strength in the machine direction to the dry tensile strength in the cross direction may generally be selected as desired. In some embodiments, a filter media has a ratio of dry tensile strength in the machine direction to dry tensile strength in the cross direction of greater than or equal to 1, greater than or equal to 1.25, greater than or equal to 1.5, greater than or equal to 1.75, greater than or equal to 2, greater than or equal to 2.5, greater than or equal to 3, greater than or equal to 3.5, greater than or equal to 4, greater than or equal to 5, greater than or equal to 6, greater than or equal to 7, greater than or equal to 8, or greater than or equal to 9. In some embodiments, a filter media has a ratio of dry tensile strength in the machine direction to dry tensile strength in the cross direction of less than or equal to 10, less than or equal to 9, less than or equal to 8, less than or equal to 7, less than or equal to 6, less than or equal to 5, less than or equal to 4, less than or equal to 3.5, less than or equal to 2, less than or equal to 1.75, less than or equal to 1.5, or less than or equal to 1.25. Combinations of the above-referenced ranges are also possible (e.g., greater than or equal to 1 and less than or equal to 10). Other ranges are also possible.

The filter media described herein may have a variety of suitable values of elongation at break. In some embodiments, a filter media has an elongation at break of greater than or equal to 5%, greater than or equal to 7.5%, greater than or equal to 10%, greater than or equal to 15%, greater than or equal to 20%, greater than or equal to 25%, greater than or equal to 30%, or greater than or equal to 40%. In some embodiments, a filter media has an elongation at break of less than or equal to 50%, less than or equal to 40%, less than or equal to 30%, less than or equal to 25%, less than or equal to 20%, less than or equal to 15%, less than or equal to 10%, or less than or equal to 7.5%. Combinations of the above-referenced ranges are also possible (e.g., greater than or equal to 5% and less than or equal to 50%). Other ranges are also possible. The elongation at break of a filter media may be determined in accordance with BCIS 03B (2018).

In some embodiments, a filter media described herein is employed as a component of a high efficiency particulate air (HEPA) or ultra-low particulate air (ULPA) filter. These filters are required to remove particulates at an efficiency level specified by EN1822:2009. In some embodiments, the filter media removes particulates at an efficiency of greater than 99.95% (H 13), greater than 99.995% (H 14), greater than 99.9995% (U 15), greater than 99.99995% (U 16), or greater than 99.999995% (U 17).

In some embodiments, a filter media described herein is suitable for HVAC applications.

In some embodiments, a filter media described herein may be a component of a filter element. That is, the filter media may be incorporated into an article suitable for use by an end user. When incorporated into a filter element, the filter media may be arranged such that a prefilter, if present, is positioned on the upstream surface. An efficiency layer, when present, may be positioned downstream of the prefilter and/or a backer, when present, may be positioned downstream of the efficiency layer. It is also possible for a backer to be the upstreammost layer, for a prefilter to be the downstreammost layer, and/or for a prefilter to be downstream of a backer.

Non-limiting examples of suitable filter elements include flat panel filters, V-bank filters (comprising, e.g., between 1 and 24 Vs), cartridge filters, cylindrical filters, conical filters, and curvilinear filters. Filter elements may have any suitable height (e.g., between 2 in and 124 in for flat panel filters, between 4 in and 124 in for V-bank filters, between 1 in and 124 in for cartridge and cylindrical filter media). Filter elements may also have any suitable width (between 2 in and 124 in for flat panel filters, between 4 in and 124 in for V-bank filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

In some embodiments, a filter media described herein may be a component of a filter element and may be pleated. The pleat height and pleat density (number of pleats per unit length of the media) may be selected as desired. In some embodiments, the pleat height may be greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, or less than or equal to 15 mm. Combinations of the above-referenced ranges are also possible (e.g., greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ in and 24 in, and/or pleat densities between 1 pleat/in and 50 pleats/in. As another example, filter media within cartridge filters or conical filters may have pleat heights between ¼ in and 24 in and/or pleat densities between ½ pleats/in and 100 pleats/in. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

### Example 1

This Example describes the fabrication and properties of four different filter media, two which of comprise a non-wetlaid, synthetic backer.

Table 1, below summarizes the structure of each filter media. Table 2, also below, summarizes selected physical properties of each filter media. The filter media comprising non-wetlaid backers were fabricated to have similar physical properties (e.g., similar initial DOP penetrations at 0.33 microns and basis weights) to the filter media comprising the wetlaid backer and to the filter media having a single glass layer. The resultant filter media comprising the non-wetlaid backers had lower initial air resistances than the filter media comprising the wetlaid backer and the filter media having a single glass layer, and so advantageously also had higher values of initial DOP gamma at 0.33 microns.

TABLE 1

| | First Layer | Second Layer | Third Layer |
|---|---|---|---|
| | (Backer) Type | (Efficiency Layer) Type | (Prefilter) Type |
| Filter | Carded | Electrospun | Meltblown |
| Media A | | | |
| Filter | Wetlaid | Electrospun | Charged |
| Media B | | | Meltblown |
| Filter | Carded | Electrospun | Meltblown |
| Media C | | | |
| Filter | Wetlaid | N/A | N/A |
| Media D | | | |

TABLE 2

| | | Initial DOP | Initial Air Resis- | |
|---|---|---|---|---|
| | | Penetration for | tance Measured Con- | |
| | | 0.33 micron | currently with Initial | Initial |
| | | Particles after | DOP Penetration for | DOP |
| | | Undergoing an | 0.33 micron Particles | Gamma |
| | | IPA Vapor | after Undergoing an | for 0.33 |
| | Basis | Discharge | IPA Vapor Discharge | micron |
| | Weight | Process | Process | Particles |
| Filter | 95 gsm | 27% | 3.1 mm H₂O | 18 |
| Media A | | | | |
| Filter | 85 gsm | 30% | 3.8 mm H₂O | 14 |
| Media B | | | | |
| Filter | 95 gsm | 40% | 2.5 mm H₂O | 16 |
| Media C | | | | |
| Filter | | 40% | 4.5 mm H₂O | 9 |
| Media D | | | | |

### Filter Media Fabrication

For each of Filter Media A-C, the first and third layers shown in Table 1 were fabricated by the procedure listed therein. Then, the second layer shown in Table 1 was fabricated by electrospinning directly onto the first layer. The first and second layers were assembled together with the third layer to form the resultant filter media.

Filter Media D was formed by wetlaying.

### Filter Media A Backer and Prefilter Composition

The backer in Filter Media A comprised a mixture of crimped monocomponent non-binder poly(ester) fibers and crimped bicomponent fibers comprising a poly(ester) component. The mixture of fibers together had an average fiber diameter of 20 micrometers, average fiber length of 2 in, and average crimp count of 5.5 CPI. The monocomponent non-binder poly(ester) fibers made up 20 wt % of the backer and the bicomponent fibers comprising a poly(ester) component made up 60 wt % of the backer. The backer further comprised a poly(ester) resin that made up 20 wt % thereof. The basis weight of the backer was 72 gsm.

The prefilter in Filter Media A comprised poly(propylene) fibers. The basis weight of the prefilter was 17 gsm.

### Filter Media B Backer and Prefilter Composition

The backer in Filter Media B comprised a mixture of uncrimped monocomponent non-binder poly(ester) fiber and uncrimped bicomponent fibers comprising a poly(ester) component. The mixture of fibers together had an average fiber diameter of 9.3 microns and an average fiber length of 0.225 in. It further comprised an acrylic resin that made up 15 wt % thereof. The basis weight of the backer was 70 gsm.

The prefilter in Filter Media B comprised poly(propylene) fibers further comprising charge-stabilizing additives. The basis weight of the prefilter was 15 gsm.

### Filter Media C Backer and Prefilter Composition

The backer in Filter Media C comprised a mixture of crimped monocomponent non-binder poly(ester) fibers and crimped bicomponent fibers comprising a poly(ester) component. The mixture of fibers together had an average fiber diameter of 20 micrometers, average fiber length of 2 in, and average crimp count of 5.5 CPI. The monocomponent non-binder poly(ester) fibers made up 16 wt % of the backer and the bicomponent fibers comprising a poly(ester) component made up 64 wt % of the backer. The backer further comprised a poly(ester) resin that made up 20 wt % thereof. The basis weight of the backer was 78 gsm.

The prefilter in Filter Media C comprised poly(propylene) fibers. The basis weight of the prefilter was 17 gsm.

### Filter Media D Composition

The backer in Filter Media D was a commercially-available HVAC single-layer filter media comprising glass fibers.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A filter media, comprising:
a first fiber web, wherein the first fiber web is a non-wetlaid fiber web, and wherein the first fiber web comprises a resin;
a second fiber web, wherein the second fiber web comprises fibers having an average diameter of greater than or equal to 0.01 micron and less than or equal to 1 micron; and
a third fiber web, wherein the third fiber web comprises fibers having an average diameter of greater than or equal to 0.8 microns and less than or equal to 8 microns,
wherein a ratio of a machine direction tensile strength of the filter media to a cross direction tensile strength of the filter media is greater than or equal to 2 and less than or equal to 10.

2. A filter media, comprising:
a first fiber web, wherein the first fiber web is a non-wetlaid fiber web, and wherein the first fiber web comprises a resin;
a second fiber web, wherein the second fiber web comprises fibers having an average diameter of greater than or equal to 0.01 micron and less than or equal to 1 micron; and
a third fiber web, wherein the third fiber web comprises fibers having an average diameter of greater than or equal to 0.8 microns and less than or equal to 8 microns,
wherein the filter media has an “F” classification of F1 and/or has a “K” classification of K1.

3. A filter media, comprising:
a first fiber web, wherein the first fiber web is a non-wetlaid fiber web, wherein the first fiber web comprises fibers, wherein the first fiber web comprises a resin, wherein both the fibers and the resin each comprise a poly(ester), and wherein the poly(ester) in the fibers and the poly(ester) in the resin together make up greater than or equal to 50 wt % and less than or equal to 100 wt % of the first fiber web;
a second fiber web, wherein the second fiber web comprises fibers having an average diameter of greater than or equal to 0.01 micron and less than or equal to 1 micron; and
a third fiber web, wherein the third fiber web comprises fibers having an average diameter of greater than or equal to 0.8 microns and less than or equal to 8 microns.

4-7. (canceled)

8. A filter media as in claim 1, wherein an adhesive is positioned between the first fiber web and the second fiber web.

9. (canceled)

10. A filter media as in claim 1, wherein an adhesive is positioned between the second fiber web and the third fiber web.

11. (canceled)

12. A filter media as in claim 1, wherein an adhesive is positioned between the first fiber web and the third fiber web.

13-14. (canceled)

15. A filter media as in claim 1, wherein the first fiber web comprises staple fibers.

16. A filter media as in claim 1, wherein greater than or equal to 50% of the staple fibers have a length of greater than or equal to 1 in and less than or equal to 4 in.

17. A filter media as in claim 1, wherein greater than or equal to 70% of the staple fibers have a length of greater than or equal to 1 in and less than or equal to 4 in.

18. (canceled)

19. A filter media as in claim 1, wherein the first fiber web comprises crimped fibers.

20-63. (canceled)

64. A filter media as in claim 1, wherein the first fiber web comprises multicomponent fibers.

65. A filter media as in claim 64, wherein the multicomponent fibers are bicomponent fibers.

66. A filter media as in claim 64, wherein the multicomponent fibers make up greater than or equal to 10 wt % of the first fiber web.

67. A filter media as in claim 64, wherein the multicomponent fibers make up greater than or equal to 30 wt % of the first fiber web.

68. A filter media as in claim 64, wherein the multicomponent fibers make up greater than or equal to 50 wt % of the first fiber web.

69. A filter media as in claim 1, wherein the first fiber web is a carded fiber web.

70. A filter media as in claim 1, wherein the second fiber web is an electrospun fiber web.

71. A filter media as in claim 1, wherein the third fiber web is a meltblown fiber web.

72. A filter media as in claim 1, wherein 100 wt % of the filter media is made up of synthetic material.

73. A filter media as in claim 1, wherein bicomponent fibers make up greater than or equal to 70 wt % and less than or equal to 90 wt % of the first fiber web, monocomponent fibers make up greater than or equal to 10 wt % and less than or equal to 30 wt % of the first fiber web, and a resin makes up greater than or equal to 10 wt % and less than or equal to 30 wt % of the first fiber web.
